(19) United States
(12) Patent Application Publication
(10) Pub. No.: US 2025/0103675 A1
(43) Pub. Date: Mar. 27, 2025

(54) PRIVACY-PRESERVING COMPUTATION METHOD AND SYSTEM FOR SECURE TWO-PARTY MATRIX HYBRID MULTIPLICATION, AND MEDIUM

(71) Applicant: Beihang University, Beijing (CN)

(72) Inventors: Shizhao Peng, Beijing (CN); Haogang Zhu, Beijing (CN); Derun Zhao, Beijing (CN)

(21) Appl. No.: 18/605,637

(22) Filed: Mar. 14, 2024

(30) Foreign Application Priority Data
Sep. 21, 2023 (CN) 202311224160.X

(51) Int. Cl. G06F 17/16

(52) U.S. Cl. CPC G06F 17/16

(57) ABSTRACT

Disclosed are a privacy-preserving computation method and system for secure two-party matrix hybrid multiplication, and a medium. The method includes: A first computation participant and a second computation participant perform secure two-party matrix multiplication based on a private matrix A1 and a private matrix B2 and based on a private matrix A2 and a private matrix B1 by using a secure two-party matrix multiplication protocol, randomly split each matrix multiplication result into two random data items. At the same time, the first computation participant performs private matrix multiplication based on the private matrix A1 and the private matrix A2, and the second computation participant performs private matrix multiplication based on the private matrix B1 and the private matrix B2. The first computation participant and the second computation participant each obtain a final outcome matrix, and send the final outcome matrix to a computation requester to compute a privacy-preserving computation result.

### CROSS REFERENCE TO RELATED APPLICATION

This patent application claims the benefit and priority of Chinese Patent Application No. 202311224160X, filed with the China National Intellectual Property Administration on Sep. 21, 2023, the disclosure of which is incorporated by reference herein in its entirety as part of the present application.

### TECHNICAL FIELD

The present disclosure relates to the field of information security, and in particular, to a privacy-preserving computation method and system for secure two-party matrix hybrid multiplication, and a medium.

### BACKGROUND

With the innovation and application of artificial intelligence and big data technologies, the world has officially entered the “data-driven” era, and data has become an important strategic resource for countries and enterprises. However, in the era of big data, it is necessary to achieve opening and sharing of data. Therefore, how to realize “availability but invisibility” of the data, to solve a problem of a data island to realize the interconnection and fusion analysis of the data becomes an urgent problem to be solved. A privacy-preserving computation technology not only realizes safe circulation of the data but also effectively ensures separation of data ownership and data use right on the premise that original data privacy is effectively guaranteed not to be disclosed. The privacy-preserving computation technology is widely used in scenarios such as collaborative big data mining, collaborative modeling in machine learning, and the like. However, model computation processes in all these scenarios generally involve complex operations of hybrid superimposition and multiplication of multi-party data. For example, in a common secure two-party linear regression problem, an intermediate computation process of (A₁+B₁)·(A₂Y+B₂Y) for computing a regression coefficient β=(X^{T}X)⁻¹X^{T}Y involves secure two-party matrix hybrid multiplication.

In a conventional technology, Benjamin and Atallah have designed an outsourced matrix hybrid computation solution based on a homomorphic encryption technology, where the solution can be verified by one or more servers. User computational complexity of the solution is O(n²t²), where n and t represent an order and a threshold of a matrix respectively. Based on different cryptographic hardness assumptions (such as a co-computational Diffie-Hellman (co-CDH) hardness assumption and a deterministic linear hardness assumption) and a secret sharing technology, researchers such as Fiore have constructed a publicly verifiable model for performing high-order polynomial computation and matrix multiplication computation in an apportioned manner.

The conventional technology has the following disadvantages: (1) The homomorphic encryption-based computation solution provided by Benjamin and Atallah effectively ensures input data privacy and computational verifiability, but greatly reduces computation efficiency due to use of the homomorphic encryption technology. In addition, collusion attacks to an outsourced third-party cloud service provider in this solution easily occur. (2) The secret sharing-based solution provided by the researchers such as Fiore improves overall computational security, but substantially increases computation overheads due to a variety of public-key cryptography tools used in this solution. In addition, quantities of rings and fields involved in the secret sharing-based solution are limited, and therefore computation precision is inadequate.

### SUMMARY

The present disclosure aims to provide a privacy-preserving computation method and system for secure two-party matrix hybrid multiplication, and a medium, to greatly improve privacy-preserving computation precision of secure two-party matrix hybrid multiplication.

To achieve the foregoing objective, the present disclosure provides the following solutions.

The present disclosure provides a privacy-preserving computation method for secure two-party matrix hybrid multiplication, involving two computation participants. A first computation participant has a private matrix A₁ and a private matrix A₂, and a second computation participant has a private matrix B₁ and a private matrix B₂. The method includes:
inputting, by the first computation participant and the second computation participant, the private matrix A₁ and the private matrix B₂ respectively based on a secure two-party matrix multiplication protocol, to perform secure two-party matrix multiplication to obtain a first matrix multiplication result; randomly splitting the first matrix multiplication result into a matrix Vₐ₁ and a matrix V_{b1} by using an obfuscation technique; and sending the matrix Vₐ₁ and the matrix V_{b1} to the first computation participant and the second computation participant respectively, where the matrix Vₐ₁ and the matrix V_{b1} satisfy an expression of Vₐ₁+V_{b1}=A₁×B₂;
inputting, by the first computation participant and the second computation participant, the private matrix A₂ and the private matrix B₁ respectively based on the secure two-party matrix multiplication protocol, to perform secure two-party matrix multiplication to obtain a second matrix multiplication result; randomly splitting the second matrix multiplication result into a matrix Vₐ₂ and a matrix V_{b2} by using the obfuscation technique; and sending the matrix Vₐ₂ and the matrix V_{b2} to the first computation participant and the second computation participant respectively, where the matrix Vₐ₂ and the matrix V_{b2} satisfy an expression of Vₐ₂+V_{b2}=B₁×A₂;
performing, by the first computation participant, private matrix multiplication to obtain a matrix Vₐ₀, where the matrix Vₐ₀ satisfies the following expression: Vₐ₀=A₁×A₂;
performing, by the second computation participant, private matrix multiplication to obtain a matrix V_{b0}, where the matrix V_{b0} satisfies the following expression: V_{b0}=B₁×B₂;
performing, by the first computation participant, local private computation on the matrix Vₐ₀, the matrix Vₐ₁, and the matrix Vₐ₂, to obtain a matrix Vₐ;
performing, by the second computation participant, local private computation on the matrix V_{b0}, the matrix V_{b1}, and the matrix V_{b2}, to obtain a matrix V_{b}; and
sending, by the first computation participant and the second computation participant, the matrix Vₐ and the matrix V_{b} respectively to a computation requester for secure two-party matrix hybrid multiplication, where the computation requester computes a privacy-preserving computation result.

The present disclosure further provides a privacy-preserving computation system for secure two-party matrix hybrid multiplication, involving two computation participants. A first computation participant has a private matrix A₁ and a private matrix A₂, and a second computation participant has a private matrix B₁ and a private matrix B₂. The system includes:
a first matrix multiplication module, configured to: be used by the first computation participant and the second computation participant to input the private matrix A₁ and the private matrix B₂ respectively based on a secure two-party matrix multiplication protocol, to perform secure two-party matrix multiplication to obtain a first matrix multiplication result; randomly split the first matrix multiplication result into a matrix Vₐ₁ and a matrix V_{b1} by using an obfuscation technique; and send the matrix Vₐ₁ and the matrix V_{b1} to the first computation participant and the second computation participant respectively, where the matrix Vₐ₁ and the matrix V_{b1} satisfy an expression of Vₐ₁+V_{b1}=A₁×B₂;
a second matrix multiplication module, configured to: be used by the first computation participant and the second computation participant to input the private matrix A₂ and the private matrix B₁ respectively based on the secure two-party matrix multiplication protocol, to perform secure two-party matrix multiplication to obtain a second matrix multiplication result; randomly split the second matrix multiplication result into a matrix Vₐ₂ and a matrix V_{b2} by using the obfuscation technique; and send the matrix Vₐ₂ and the matrix V_{b2} to the first computation participant and the second computation participant respectively, where the matrix Vₐ₂ and the matrix V_{b2} satisfy an expression of Vₐ₂+V_{b2}=B₁×A₂;
a first local private computation module, configured to be used by the first computation participant to perform private matrix multiplication to obtain a matrix Vₐ₀, where the matrix Vₐ₀ satisfies the following expression: Vₐ₀=A₁×A₂;
a second local private computation module, configured to be used by the second computation participant to perform private matrix multiplication to obtain a matrix V_{b0}, where the matrix V_{b0} satisfies the following expression: V_{b0}=B₁×B₂;
a first matrix computation module, configured to be used by the first computation participant to perform local private computation on the matrix Vₐ₀, the matrix Vₐ₁, and the matrix Vₐ₂, to obtain a matrix Vₐ;
a second matrix computation module, configured to be used by the second computation participant to perform local private computation on the matrix V_{b0}, the matrix V_{b1}, and the matrix V_{b2}, to obtain a matrix V_{b}; and
a privacy-preserving computation result output module, configured to: be used by the first computation participant and the second computation participant to send the matrix Vₐ and the matrix V_{b} respectively to a computation requester for secure two-party matrix hybrid multiplication, where the computation requester computes a privacy-preserving computation result.

The present disclosure further provides a computer-readable storage medium, storing a computer program, where when the computer program is run on a processor, the privacy-preserving computation method for secure two-party matrix hybrid multiplication is performed.

According to specific embodiments provided in the present disclosure, the present disclosure has the following technical effects:

The present disclosure provides a privacy-preserving computation method and system for secure two-party matrix hybrid multiplication, and a medium. The present disclosure proposes an end-to-end parallel hybrid multiplication solution for a semi-honest environment based on a basic secure two-party matrix multiplication protocol 2PMP, to solve prior-art problems of high communication overheads and a large ciphertext computation space that are caused due to use of homomorphic encryption and oblivious transfer technologies. Key steps S1 and S3 for ensuring stable hybrid computation precision are provided. A key to ensuring computation precision in the present disclosure is use of the secure two-party matrix multiplication protocol 2PMP that supports computation with precision up to a 64-bit floating number. This solves a prior-art problem that numerical precision of floating point computation is inadequate because a quantity of ciphertext digits is fixed.

### BRIEF DESCRIPTION OF THE DRAWINGS

To describe the technical solutions in embodiments of the present disclosure or in the prior art more clearly, the accompanying drawings required in the embodiments are briefly described below. Apparently, the accompanying drawings in the following description show merely some embodiments of the present disclosure, and other drawings can be derived from these accompanying drawings by those of ordinary skill in the art without creative efforts.

FIG. 1 is a schematic diagram of a secure two-party matrix hybrid multiplication problem according to Embodiment 1 of the present disclosure;

FIG. 2 is a schematic diagram of a secure two-party matrix multiplication problem according to Embodiment 1 of the present disclosure;

FIG. 3 is a flowchart of a secure two-party matrix multiplication protocol according to Embodiment 1 of the present disclosure;

FIG. 4 is a flowchart of a secure two-party matrix hybrid multiplication protocol for a semi-honest environment according to Embodiment 1 of the present disclosure;

FIG. 5 is a schematic diagram of a secure multi-party data obfuscation technique according to Embodiment 1 of the present disclosure;

FIG. 6 is a flowchart of a privacy-preserving computation method for secure two-party matrix hybrid multiplication according to Embodiment 1 of the present disclosure;

FIG. 7 is a specific flowchart of Step S1 in a privacy-preserving computation method for secure two-party matrix hybrid multiplication according to Embodiment 2 of the present disclosure;

FIG. 8 is a schematic diagram of a rank-preserving secure 2-party matrix addition decomposition technique according to Embodiment 2 of the present disclosure;

FIG. 9 is a specific flowchart of Step S2 in a privacy-preserving computation method for secure two-party matrix hybrid multiplication according to Embodiment 2 of the present disclosure; and

FIG. 10 is a flowchart of a secure two-party matrix hybrid multiplication protocol that is for a privacy leakage environment and that corresponds to a specific instance according to Embodiment 2 of the present disclosure.

### DETAILED DESCRIPTION OF THE EMBODIMENTS

The technical solutions in embodiments of the present disclosure are clearly and completely described below with reference to the accompanying drawings in the embodiments of the present disclosure. Apparently, the described embodiments are merely some but not all of the embodiments of the present disclosure. All other embodiments obtained by those skilled in the art based on the embodiments of the present disclosure without creative efforts shall fall within the protection scope of the present disclosure.

In a conventional technology, researchers such as Zhen and Jia have constructed, with reference to an oblivious transfer protocol, a secure two-party matrix hybrid computing protocol that can be used to solve an n-order matrix equation. However, the solution that is based on the oblivious transfer protocol OT₁ⁿ involves a large quantity of rounds of communication interaction. Therefore, for a large-scale data matrix hybrid multiplication task, communication costs are high and computation efficiency is low. In addition, all the conventional technical solutions mentioned in the present disclosure are implemented based on cryptographic technology stacks. This can ensure security in a semi-honest environment. However, a problem that leakage of an output result may cause a risk to original data privacy is unsolved when secure two-party matrix computation is involved.

Based on a secure two-party matrix hybrid multiplication problem, the present disclosure aims to provide a basic privacy-preserving computation method and apparatus that feature high-efficiency, safety, reliability, and high coupling performance. To this end, the present disclosure aims to solve the following technical problems:
(1) Most existing solutions to a problem involving secure two-party matrix hybrid multiplication use cryptographic technology stacks such as homomorphic encryption, oblivious transfer, and secret sharing to serially perform each corresponding step subsequent to hybrid multiplication decomposition. Consequently, complexity of ciphertext space computation is significantly increased and communication overheads double.
(2) Most existing protocols involving secure two-party matrix hybrid multiplication are based on a semi-honest environment, and ignore a result security problem caused by an input full-rank matrix in a data leakage environment.
(3) Most existing solutions to a problem involving secure two-party matrix hybrid multiplication rely on an outsourced cloud service computing system. If a third-party cloud service computing node is not highly trustworthy or is attacked by a malicious node, key leakage may occur, and a security risk of original data privacy leakage may be further caused.
(4) Most existing solutions to a problem involving secure two-party matrix hybrid multiplication use a large prime number for encryption. This increases a quantity of ciphertext digits in a computing space. In addition, the quantity of ciphertext digits is fixed. Consequently, numerical computation precision is inadequate, and reliability of a computation result is affected.

The present disclosure aims to achieve the following objectives:
(1) The present disclosure implements, based on a basic secure two-party matrix multiplication protocol 2PMP, two hybrid multiplication solutions for different scenarios in an end-to-end parallel computing mode. This solves prior-art problems of high communication overheads and a large ciphertext computation space that are caused due to use of homomorphic encryption and oblivious transfer technologies. In addition, this implements a secure two-party matrix hybrid multiplication solution in a parallel, safe, and reliable manner without relying on a third-party cloud service. (This aims to solve the foregoing problems (1) and (3)).
(2) The present disclosure provides a rank-preserving mechanism for matrix addition decomposition and a rank-preserving secure 2-party matrix addition decomposition technique, to solve a problem that a rank of an input matrix in a prior-art solution essentially cannot be decomposed in an independent or controllable manner. (This aims to solve the foregoing problems (1), (2), (3), and (4)).
(3) The present disclosure uses the basic secure two-party matrix multiplication protocol and the rank-preserving secure 2-party matrix addition decomposition technique to implement hybrid multiplication in an eight-link parallel computing mode. This solves a prior-art problem that data result leakage causes a potential risk to original data privacy. (This aims to solve the foregoing problems (1), (2), (3), and (4)).
(4) In the present disclosure, the secure two-party matrix multiplication protocol 2PMP that can support computation with precision up to a 64-bit floating point and that supports result reliability verification is used. This solves a prior-art problem that numerical precision of floating point computation is inadequate because the quantity of ciphertext digits is fixed. In addition, this implements a secure two-party matrix hybrid multiplication protocol that can support high-precision floating point matrix computation. (This aims to solve the foregoing problems (1) and (2)).

In order to make the foregoing objectives, features, and advantages of the present disclosure clearer and more comprehensible, the present disclosure is further described in detail below with reference to the accompanying drawings and specific implementations.

### Embodiment 1

The embodiment provides a privacy-preserving computation method for secure two-party matrix hybrid multiplication, involving two computation participants. A first computation participant has a private matrix A₁ and a private matrix A₂, and a second computation participant has a private matrix B₁ and a private matrix B₂. The method is applied to a semi-honest computation environment. Semi-honest adversaries security (Semi-Honest Adversaries Security) is a specific protocol assuming that all computation participants honestly perform privacy-preserving computation and perform each procedure in strict accordance with the protocol, but there are some risks caused by a corrupt participant who attempts to infer privacy of another participant based on an intermediate or final result obtained in a protocol execution process.

To make the solution in this embodiment clearer, the following terms are first introduced:

Privacy-preserving computation (Privacy-Preserving Computation) refers to a series of information technologies that perform data analysis and computation on the premise that a data provider does not leak original data, which ensures that data is “available but invisible” during circulation and fusion.

Secure two-party matrix hybrid multiplication protocol (2PHMP, Secure Two-Party Matrix Hybrid Multiplication Protocol) problem: As shown in FIG. 1, there are two independent computation participants Alice and Bob who distrust each other. Alice has a pair of private data matrices A₁ and A₂ that are stored only on a computing node of Alice, where A₁∈R^{m×t} and A₂∈R^{t×n}. Bob has a pair of private data matrices B₁ and B₂ that are stored only on a computing node of Bob, where B₁∈R^{m×t} and B₂∈R^{t×n}. The two computation participants collaboratively perform a two-party matrix hybrid multiplication protocol f((A₁, A₂), (B₁, B₂))=(A₁+B₁)×(A₂+B₂)=Vₐ+V_{b}. Finally, the computation participant nodes respectively obtain corresponding output matrices Vₐ, V_{b}∈R^{m×n}, and send the output matrices to a computation requester for summarization, so as to obtain a two-party matrix hybrid multiplication result desired by the computation participants. In a computation process, each participant node can obtain only input and output information involved in the computation process of the computation participant, but cannot obtain an intermediate computation result and private data information of another computation participant.

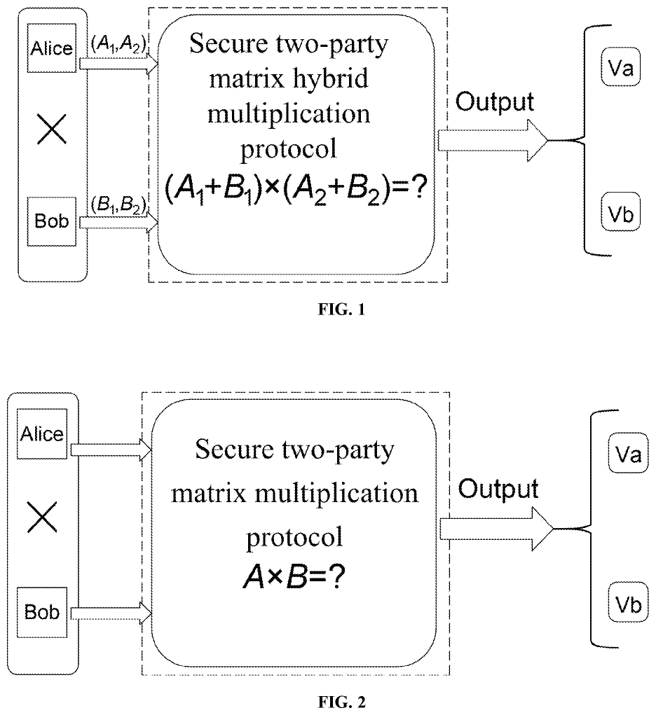

Secure two-party matrix multiplication protocol (2PMP) problem: There are two independent computation participants Alice and Bob who distrust each other. Alice has a private data matrix A whose dimension is n×s and that is stored only on a computing node of Alice. Bob has a private data matrix B whose dimension is s×m and that is stored only on a computing node of Bob. The two computation participants hope to collaboratively perform a secure matrix multiplication protocol f(A, B)=AB=Vₐ+V_{b}. Finally, the computation participant nodes respectively obtain corresponding output matrices Vₐ, V_{b} whose dimensions both are n×m, and send the output matrices to a computation requester for summarization, so as to obtain a two-party matrix multiplication result desired by the computation participants. In a computation process, each participant node can obtain only input and output information of the computation participant, but cannot obtain an intermediate computation result and data information of another computation participant. For a formalized description of the problem, refer to FIG. 2. The involved secure two-party matrix multiplication protocol 2PMP may alternatively be replaced by an existing cryptography tool such as secret sharing, oblivious transfer, an obfuscation circuit, or fully homomorphic encryption.

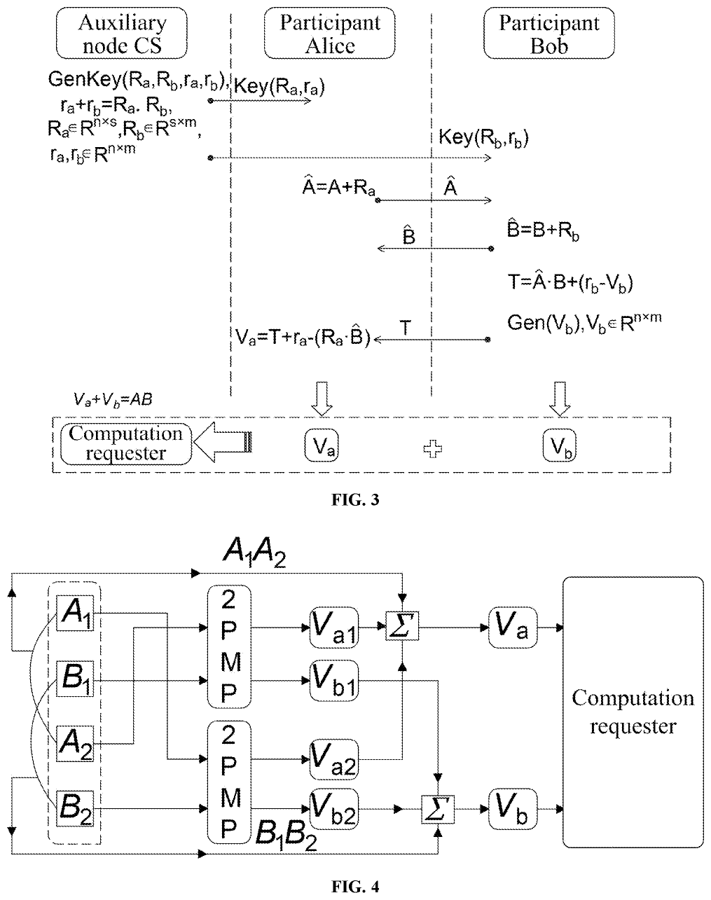

FIG. 3 is a flowchart of a secure two-party matrix multiplication protocol (2PMP).

Step 1: An auxiliary computing node, also referred to as a commodity server CS(CommodityServer) node, generates two random matrix pairs: a random matrix Rₐ whose dimension is n×s, a random matrix R_{b} whose dimension is s×m, and two random matrices rₐ, r_{b} whose dimensions both are n×m. These random matrices need to strictly satisfy a constraint of rₐ+r_{b}=Rₐ·R_{b}. Then, the CS auxiliary node sends a random matrix pair (Rₐ, rₐ) to a computing node of a participant Alice, and a random matrix pair (R_{b}, r_{b}) to a computing node of a participant Bob.

Step 2: After receiving the corresponding random matrix pair (Rₐ, rₐ), the participant Alice computes Â=A+Rₐ inside the node of Alice, and sends Â to the node of the participant Bob.

Step 3: After receiving the corresponding random matrix pair (R_{b}, r_{b}), the participant Bob computes \hat{B}=B+R_{b} inside the node of Bob, and sends \hat{B} to the node of the participant Alice.

Step 4: After receiving the matrix Â from the node of Alice, the node of the participant Bob secretly generates a random matrix V_{b}∈R^{n×m} internally, secretly computes a matrix T=Â ·B+(r_{b}−V_{b}) locally, and sends the matrix to the node of Alice.

Step 5: After receiving T, the node of the participant Alice secretly computes a matrix Vₐ=T+rₐ−(Rₐ·\hat{B}) locally.

Step 6: The node of the participant Alice and the node of the participant Bob send, to a computation requester of two-party matrix multiplication, results Vₐ and V_{b} that are obtained through obfuscation and splitting and that correspond to Alice and Bob respectively. The requester obtains a final product AB=Vₐ+V_{b} through summarization.

It can be readily verified that:

$${V}_{a} + {V}_{b} = [ ( \hat{A} \cdot B + ( {r}_{b} - {V}_{b} ) ) + {r}_{a} - ( {R}_{a} \cdot \hat{B} ) ] + {V}_{b} = [ ( A \cdot B - {V}_{b} ) + ( {r}_{a} + {r}_{b} - {R}_{a} \cdot {R}_{b} ) ] + {V}_{b} = A \cdot B .$$

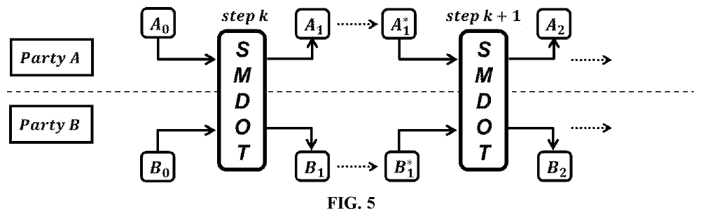

Secure multi-party data obfuscation technique (SMDOT): In most cases, more than one procedure needs to be performed to ensure secure computation during multi-party computation. Therefore, how to ensure safety of an intermediate result is an inevitable problem. For example, a product A×B of two-party matrixes is used as an intermediate computation result. In this case, regardless of whether the participant node Alice or the participant node Bob obtains a result of a final matrix A×B, data information of the other participant may possibly be deduced reversely. Therefore, not only safety of an original data input but also safety of an intermediate value need to be ensured during a privacy-preserving computation process. In order to solve this problem, a data obfuscation encryption technique is proposed in the present disclosure. To be specific, an arbitrary multi-item operation is split into a new multi-item addition method for obfuscating and computing a result of an intermediate value. To illustrate its principle more easily, a basic two-party operation type is exemplified herein, and its principle is shown in FIG. 4.

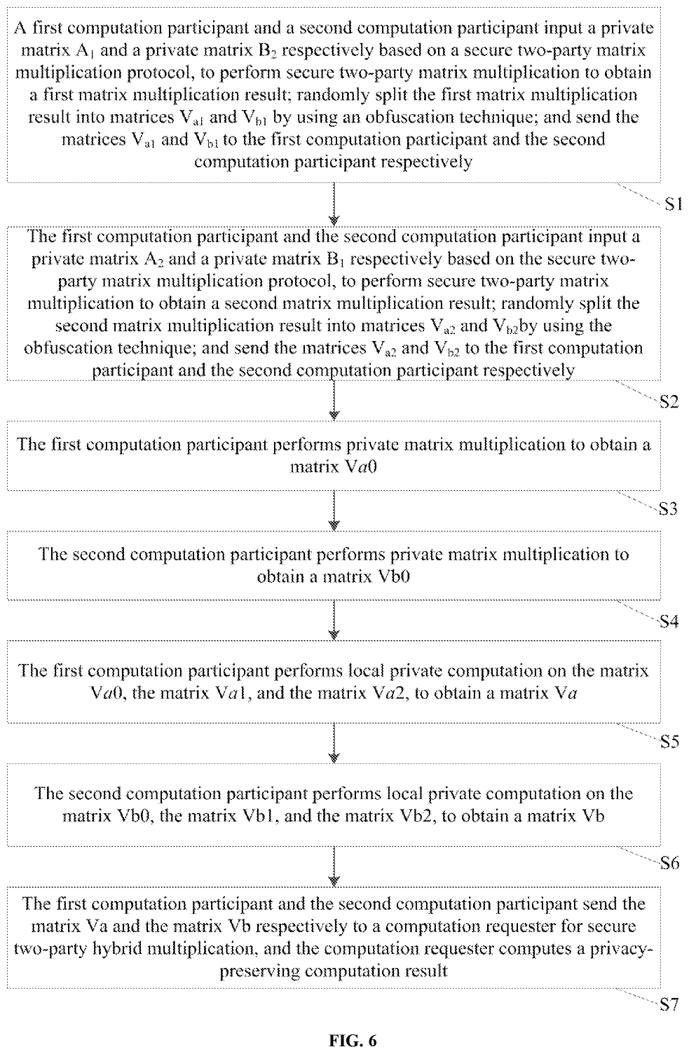

It is assumed that Sₖ=Fₖ(Aᵢ, Bᵢ), where Fₖ represents an objective computation function and corresponds to SMDOT (which generally refers to a secure multi-party computing protocol, Secure Multi-Party Data Obfuscation Technique) in FIG. 5. Aᵢ represents private data of the computation participant Alice and Bᵢ represents private data of the computation participant Bob. When each sub protocol of the secure multi-party computing protocol is performed, the intermediate result Sₖ strictly complies with the following constraint: Alice knows only a computation result Aₖ of Alice, Bob knows only Bₖ, and Aₖ+Bₖ=Sₖ. A formula [Aᵢ: Bᵢ]→[Aₖ:Bₖ|Aₖ+Bₖ=Fₖ(Aᵢ, Bᵢ)] represents a transfer process of the intermediate value. In the entire process, Alice and Bod are not allowed to exchange data information between each other, including Aₖ and Bₖ that are obtained by splitting the intermediate computation result. If it is ensured that the intermediate value is split into two random data items in each sub protocol during computation, it is possible to ensure that no computation participant can reversely deduce an original data item from the obfuscated and encrypted data. In this way, the whole privacy-preserving computation process has high safety.

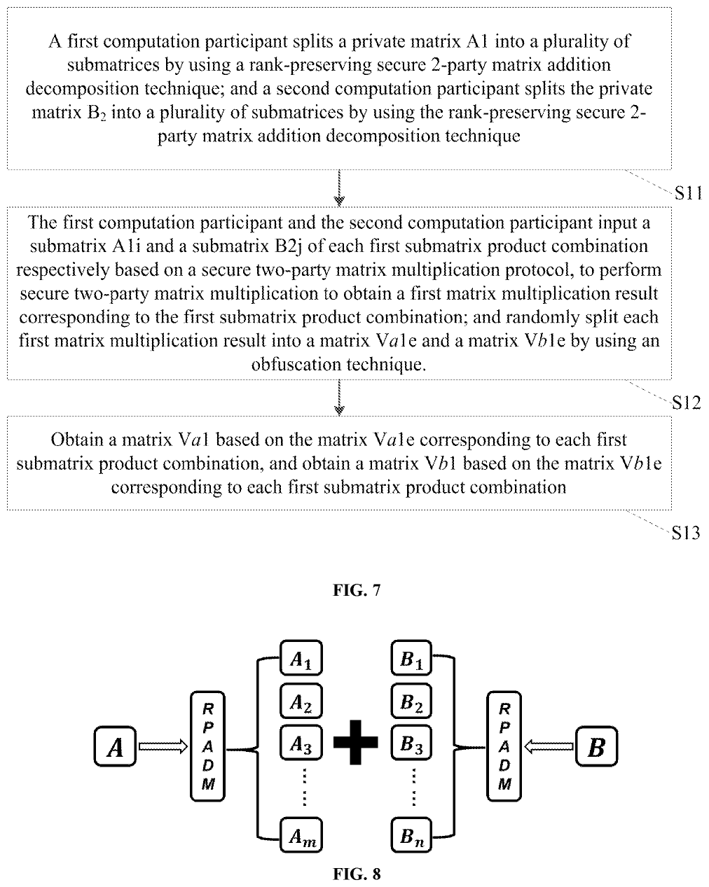

Specifically, as shown in FIG. 6, the method includes:

Step S1: A first computation participant (that is, a node of a computation participant Alice) and a second computation participant (that is, a node of a computation participant Bob) input a private matrix A₁∈R^{m×t} and a private matrix B₂∈R^{t×n} respectively based on a secure two-party matrix multiplication protocol 2PMP, to perform secure two-party matrix multiplication to obtain a first matrix multiplication result. After 2PMP protocol computation is completed, the first matrix multiplication result is randomly split into matrices Vₐ₁∈R^{m×n}, V_{b1}∈R^{m×n}. Then, the matrices Vₐ₁ and V_{b1} are sent to the first computation participant and the second computation participant respectively, where the matrices Vₐ₁ and V_{b1} satisfy an expression of Vₐ₁+V_{b1}=A₁×B₂.

Step S2: The first computation participant and the second computation participant input a private matrix A₂∈R^{m×t} and a private matrix B₁∈R^{t×n} respectively based on the secure two-party matrix multiplication protocol 2PMP, to perform secure two-party matrix multiplication to obtain a second matrix multiplication result. After 2PMP protocol computation is completed, the second matrix multiplication result is randomly split into matrices Vₐ₂∈R^{m×n}, V_{b2}∈R^{m×n} by using the obfuscation technique. Then, the matrices Vₐ₂ and V_{b2} are sent to the first computation participant and the second computation participant respectively, where the matrices Vₐ₂ and V_{b2} satisfy an expression of Vₐ₂+V_{b2}=B₁×A₂. Step S2 and Step S1 are performed in parallel.

Step S3: The first computation participant performs private matrix multiplication locally to obtain a matrix Vₐ₀ and stores, after computation is completed, the result in a private storage space inside a local node of Alice, where the matrix Vₐ₀ satisfies the following expression: Vₐ₀=A₁×A₂. Step S3 and Step S1 are performed in parallel.

Step S4: The second computation participant performs private matrix multiplication locally to obtain a matrix V_{b0} and stores, after computation is completed, the result in a private storage space inside a local node of Bob, where the matrix V_{b0} satisfies the following expression: V_{b0}=B₁×B₂. Step S4 and Step S1 are performed in parallel.

Step S5: The first computation participant secretly summarizes the matrix Vₐ₁ and the matrix Vₐ₂, and performs private computation Vₐ=Vₐ₀+Vₐ₁+Vₐ₂ locally, where Vₐ∈R^{m×n}.

Step S6: The second computation participant secretly summarizes the matrix V_{b1} and the matrix V_{b2}, and performs private computation V_{b}=V_{b0}+V_{b1}+V_{b2} locally, where V_{b}∈R^{m×n}.

Step S7: The first computation participant and the second computation participant send the matrix Vₐ and the matrix V_{b} respectively to a computation requester for secure two-party matrix hybrid multiplication, and the computation requester obtains a final computation result (A₁+B₁)×(A₂+B₂)=Vₐ+V_{b} through summarization.

It can be readily verified that:

$${V}_{a} + {V}_{b} = ( {V}_{a 0} + {V}_{a 1} + {V}_{a 2} ) + ( {V}_{b 0} + {V}_{b 1} + {V}_{b 2} ) = {V}_{a o} + {V}_{b 0} + ( {V}_{a 1} + {V}_{b 2} ) + ( {V}_{a 2} + {V}_{b 1} ) = ( {A}_{1} \times {A}_{2} ) + ( {B}_{1} \times {B}_{2} ) + ( {A}_{1} \times {B}_{2} ) + ( {B}_{1} \times {A}_{2} ) = ( {A}_{1} + {B}_{1} ) \times ( {A}_{2} + {B}_{2} ) .$$

In this embodiment, the present disclosure proposes an end-to-end parallel hybrid multiplication solution for a semi-honest environment based on a basic secure two-party matrix multiplication protocol 2PMP. In addition, computation in Steps S1 to S4 are performed in parallel. This solves prior-art problems of high communication overheads and a large ciphertext computation space that are caused due to use of homomorphic encryption and oblivious transfer technologies.

In this embodiment, key steps S1 and S3 for ensuring stable hybrid computation precision are provided. A key to ensuring computation precision in the present disclosure is use of the secure two-party matrix multiplication protocol 2PMP that supports computation with precision up to a 64-bit floating number. This solves a prior-art problem that numerical precision of floating point computation is inadequate because a quantity of ciphertext digits is fixed.

### Embodiment 2

Different from Embodiment 1, in Embodiment 2, a rank-preserving secure 2-party matrix addition decomposition technique is used to perform secure two-party matrix multiplication on a private matrix A₂ and a private matrix B₁ in Step S1 and to perform secure two-party matrix multiplication on a private matrix A₁ and a private matrix B₂ in Step S2 in Embodiment 1.

A semi-honest computation environment is ideal, and has high requirements for a network communication environment and computing node reliability. However, in an actual engineering application scenario, if data of an intermediate process or data of a fragment matrix of a final output result is leaked, input data information involved in a computing protocol may have a security risk of privacy leakage even if participant nodes do not disclose computation information to each other. The privacy risk is mainly caused by a data structure of a matrix at an input end of a secure two-party matrix multiplication protocol 2PMP serving as a basis of a multi-party computation framework. Specifically, for a multiplication operation F(A, B)=A×B=Vₐ+V_{b}=M of any two input matrices in a real number field, a final multiplication result M=A×B is directly exposed if one of output submatrices Vₐ and V_{b} is exposed due to an attack from a node of a malicious participant. Further, a participant may possibly derive, by solving a matrix equation AX=M or XB=M, input data of the other participant based on a final computation result of two-party matrix multiplication and a matrix input by the participant for computation. For example, this case applies when a participant inputs an invertible matrix. To solve a secure two-party matrix hybrid multiplication problem in the foregoing problem scenario, this embodiment provides a privacy-preserving computation method for secure two-party matrix hybrid multiplication, involving two computation participants. A first computation participant has a private matrix A₁ and a private matrix A₂, and a second computation participant has a private matrix B₁ and a private matrix B₂. The method applies to a scenario with a privacy leakage risk. The privacy risk is mainly caused by a data structure of a matrix at an input end of a secure two-party matrix multiplication protocol 2PMP serving as a basis of a multi-party computation framework. Specifically, for a multiplication operation F(A, B)=A×B=Vₐ+V_{b}=M of any two input matrices in a real number field, a final multiplication result M=A×B is directly exposed if one of output submatrices Vₐ and V_{b} is exposed due to an attack from a node of a malicious participant. Further, a participant may possibly derive, by solving a matrix equation AX=M or XB=M, input data of the other participant based on a final computation result of two-party matrix multiplication and a matrix input by the participant for computation. For example, this case applies when a participant inputs an invertible matrix. To solve a secure two-party matrix hybrid multiplication problem in the foregoing problem scenario, the present disclosure designs a secure two-party matrix hybrid multiplication protocol for the scenario with a privacy leakage risk.

Specifically, as shown in FIG. 6, the method includes:

Step S1: The first computation participant and the second computation participant input the private matrix A₁ and the private matrix B₂ respectively based on the secure two-party matrix multiplication protocol, to perform secure two-party matrix multiplication to obtain a first matrix multiplication result; randomly split the first matrix multiplication result into matrices Vₐ₁ and V_{b1} by using an obfuscation technique; and send the matrices Vₐ₁ and V_{b1} to the first computation participant and the second computation participant respectively, where the matrices Vₐ₁ and V_{b1} satisfy an expression of Vₐ₁+V_{b1}=A₁×B₂.

As shown in FIG. 7, Step S1 specifically includes:

Step S11: The first computation participant splits the private matrix A₁ into a plurality of submatrices by using a rank-preserving secure 2-party matrix addition decomposition technique; and the second computation participant splits the private matrix B₂ into a plurality of submatrices by using the rank-preserving secure 2-party matrix addition decomposition technique. The private matrix A₁=A₁₁+A₁₂+A₁ᵢ+ . . . +A_{1N}_{₁}, the private matrix B₂=B₂₁+B₂₂+B₂ⱼ+ . . . +B_{2T}_{₁}, a rank of the private matrix A₁ equals a sum of ranks of all submatrices A₁ᵢ, and a rank of the private matrix B₂ equals a sum of ranks of all submatrices B₂ⱼ.

The following describes the rank-preserving secure 2-party matrix addition decomposition technique (RS2MADT).

A key to matrix decomposition is to find a specific matrix sequence A₁, A₂, . . . , Aₙ∈R^{m×n}, so that row spaces of any two matrices in the sequence do not intersect and column spaces of any two matrices in the sequence do not intersect, that is, dimension (C(Aᵢ)∩C(Aⱼ))=dimension (R(Aᵢ)∩R(Aⱼ))=0 and A=A₁+A₂+ . . . +Aₙ. In this case, the matrix sequence that features pairwise linear independence in row and column spaces is a rank-preserving submatrix sequence of an original matrix A. An ultimate goal of secure 2-party matrix addition decomposition is to convert addition of two matrices into addition of two non-full-rank matrix sequences without exposing data information of each other, as shown in FIG. 8, to implement form transformation of A+B=Σ₁^{N}^{₁}(A₁)+Σ₁^{T}^{₁}Bⱼ from a two-item operation to a multi-item operation, so as to tackle a security risk that is caused due to data leakage in the two-party matrix hybrid multiplication protocol.

A rank of any matrix M∈R^{m×n} satisfies the following requirement: r(M)=r≥1. A goal of addition decomposition is to decompose a matrix into a series of submatrices so that a sum of ranks of the submatrices equal a rank of the original matrix. Therefore, there is no need to perform decomposition on a matrix whose rank equals 1. For any matrix M whose rank is greater than 1 and dimension is (m, n), elementary row/column transformation can be performed to transform the matrix into a canonical matrix

$$F = {( \begin{matrix}{E}_{r} & O \\ O & O\end{matrix} )}_{m \times n} .$$

The canonical matrix is fully determined by parameters m, n, and r, where r represents a rank of the original matrix. For the canonical matrix F, it is assumed that m<n. r(F)=r(Eᵣ)=r(M)=r≤min(m, n)=n. Therefore, the canonical matrix F can be decomposed into 2≤N≤n submatrices F₁, F₂, . . . , F_{N}. In addition, each of the submatrices is a sparse diagonal matrix that consists of elements 0 and 1. For example,

$$F = {( \begin{matrix}{E}_{r} & O \\ O & O\end{matrix} )}_{m \times n} = ( \begin{matrix}diag ( {I}_{r 1} , 0 , … 0 , 0 ) & O \\ O & O\end{matrix} ) + ( \begin{matrix}diag ( 0 , {I}_{r 2} , 0 , … 0 ) & O \\ O & O\end{matrix} ) + … + ( \begin{matrix}diag ( 0 , 0 , … 0 , {I}_{rN} ) & O \\ O & O\end{matrix} ) = {F}_{1} + {F}_{2} + … + {F}_{N} ,$$

where F

$${F}_{i} = ( \begin{matrix}diag ( 0 , 0 , … {I}_{ri} , … , 0 , 0 ) & O \\ O & O\end{matrix} ) ,$$

and Iᵣᵢ is a non-zero sub-block corresponding to a sparse diagonal matrix Fᵢ that includes ri elements 1 and that is obtained by performing row/column partitioning on the canonical matrix F without overlapping. Apparently, if (i≠j), Fᵢ and Fⱼ strictly comply with a constraint that any two row spaces do not intersect and any two column spaces do not intersect. Therefore, a canonical matrix F of any matrix M with a dimension of (m, n) in a real number field can be decomposed into a finite number of submatrices that are rank-preserving when addition is performed. In addition, for any matrix Fᵢ, elementary row/column transformation does not change a rank of the matrix nor spatial distribution of the matrix, and an equation r(Fᵢ)=r(P·Fᵢ·Q) is always true. Therefore, for any input matrix M, there is a pair of invertible matrices P and Q that respectively correspond to a matrix obtained through elementary row transformation and a matrix obtained through elementary column transformation, where PMQ=F. Correspondingly, for a sequence of canonical matrices F₁, F₂, . . . , F_{N} among which every two spaces are linearly independent, elementary inverse transformation can be performed on the matrices to obtain a sequence of matrices Mᵢ=P⁻¹·Fᵢ·Q⁻¹(i=1, 2, . . . , N) that are in a one-to-one correspondence with the sequence of canonical matrices. Elementary transformation is invertible transformation. In addition, for any two canonical submatrices, elementary row/column transformation does not change distribution of row and column spaces of the canonical submatrices. Therefore, for any two matrices Mᵢ and Mⱼ that are obtained by performing inverse transformation, row and column spaces of the matrices correspond to distribution characteristics of the canonical matrix and strictly satisfy the following conditions: dimension (C(Mᵢ)∩C(Mⱼ))=dimension (R(Mᵢ)∩R(Mⱼ))=0 and M₁+M₂+ . . . +M_{N}=ΣMᵢ=ΣP⁻¹·Fᵢ·Q⁻¹=P⁻¹·ΣFᵢ·Q⁻¹=P⁻¹FQ⁻¹=M. Therefore, for any matrix whose rank is greater than 1, a sequence of matrices can be provided and used as rank-preserving submatrices obtained after the matrix is decomposed.

The rank-preserving secure 2-party matrix addition decomposition technique not only decomposes an original matrix, that is, randomly obfuscates information that is obtained by splitting data of the matrix, but also reduces a rank of the original matrix. Specifically, “rank reduction” herein refers to a phenomenon that after the original matrix is decomposed into submatrices, a rank of each submatrix is smaller than the rank of the original matrix. Different from rank preservation, rank reduction studies a process from the original matrix to the submatrix as a process in which an individual property changes from point to point. In contrast, rank-preservation studies a systematic process in which an overall rank throughout addition computation remain unchanged before and after decomposition. Based on the foregoing design concepts and research purposes, the present disclosure proposes the rank-preserving secure 2-party matrix addition decomposition technique (RS2MADT, Rank-Preserving Secure 2-Party Matrix Addition Decomposition Technique).

An example in which the private matrix A₁ is decomposed into a plurality of submatrices by using the rank-preserving secure 2-party matrix addition decomposition technique is used for description. Therefore, in Step S11, that the first computation participant splits the private matrix A₁ into a plurality of submatrices by using a rank-preserving secure 2-party matrix addition decomposition technique specifically includes:
(1) The first computation participant determines the rank of the private matrix A₁; determines whether the rank of the private matrix A₁ equals 1; and if the rank of the private matrix A₁ equals 1, that is, if a row space and a column space each include only one basis vector, skips performing matrix decomposition and outputs the original private matrix A₁. In this case, no matrix decomposition is performed on the private matrix A₁.
(2) If the rank of the private matrix A₁ does not equal 1, the first computation participant performs elementary row transformation (a Gauss-Jordan elimination method is used for elementary row transformation) on the private matrix A₁ to obtain a row echelon matrix and a non-singular matrix Pₐ of the private matrix A₁, and performs elementary column transformation on the row echelon matrix to obtain a canonical matrix F and a non-singular matrix Qₐ of the private matrix A₁.
(3) The first computation participant decomposes the canonical matrix F into N₁ canonical submatrices F₁, F₂, . . . , F_{N}∈R^{m×n} based on the rank of the private matrix A₁ and a preset matrix decomposition quantity N₁ of the private matrix A₁ in a manner of performing row/column partitioning without overlapping. Each canonical submatrix includes a sparse diagonal matrix and a null matrix, and the sparse diagonal matrix consists of elements 0 and 1. 2≤N₁≤n, and

$${F}_{i} = ( \begin{matrix}diag ( 0 , 0 , … {I}_{ri} , … , 0 , 0 ) & O \\ O & O\end{matrix} ) ,$$

where Iᵣᵢ(i=1, 2, . . . , N₁) is a non-zero sub-block of a canonical submatrix Fᵢ obtained through decomposition.
(4) The first computation participant performs invertible transformation on each canonical submatrix Fᵢ based on the non-singular matrix Pₐ and the non-singular matrix Qₐ, to obtain N₁ submatrices A₁ᵢ=Pₐ⁻¹·Fⁱ·Qₐ⁻¹.

Similar processing is performed on the private matrix B₂ by using the foregoing steps (1) to (4), and the private matrix B₂ is decomposed into T₁ linearly independent row and column spaces based on a decomposition quantity requirement. In this way, a final target submatrix B₂ⱼ=P_{b}⁻¹·Fᵢ·Q_{b}⁻¹(j=1, 2, . . . , T₁) may be obtained.

Step S12: The first computation participant and the second computation participant input a submatrix A₁ᵢ and a submatrix B₂ⱼ of each first submatrix product combination respectively based on the secure two-party matrix multiplication protocol, to perform secure two-party matrix multiplication to obtain a first matrix multiplication result corresponding to the first submatrix product combination; and randomly split each first matrix multiplication result into a matrix Vₐ₁ₑ and a matrix V_{b1e} by using the obfuscation technique. Each submatrix of the private matrix A₁ and each submatrix of the private matrix B₂ are randomly combined to obtain N₁×T₁ first submatrix product combinations, i=1, 2, . . . , and N₁; j=1, 2, . . . , and T₁; e=1, 2, . . . , and N₁×T₁.

Steps S12 corresponding to all first submatrix product combinations may be performed in parallel.

Step S13: Obtain the matrix Vₐ₁ based on the matrix Vₐ₁ₑ corresponding to each first submatrix product combination, and obtain the matrix V_{b1} based on the matrix V_{b1e} corresponding to each first submatrix product combination.

Step S2: The first computation participant and the second computation participant input the private matrix A₂ and the private matrix B₁ respectively based on the secure two-party matrix multiplication protocol, to perform secure two-party matrix multiplication to obtain a second matrix multiplication result; randomly split the second matrix multiplication result into matrices Vₐ₂ and V_{b2} by using the obfuscation technique; and send the matrices Vₐ₂ and V_{b2} to the first computation participant and the second computation participant respectively, where the matrices Vₐ₂ and V_{b2} satisfy an expression of Vₐ₂+V_{b2}=B₁×A₂. Steps S2 and S1 may be performed in parallel.

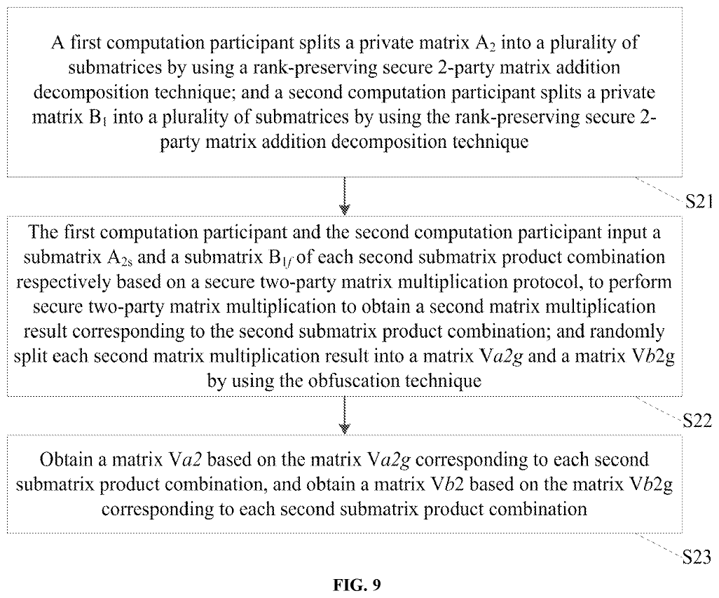

As shown in FIG. 9, Step S2 specifically includes:

Step S21: The first computation participant splits the private matrix A₂ into a plurality of submatrices by using the rank-preserving secure 2-party matrix addition decomposition technique; and the second computation participant splits the private matrix B₁ into a plurality of submatrices by using the rank-preserving secure 2-party matrix addition decomposition technique. The private matrix A₂=A₂₁+A₂₂+A₂ₛ+ . . . +A_{2N}_{₂}, the private matrix B₁=B₁₁+B₁₂+B_{1f}+ . . . +B_{1T}_{₂}, a rank of the private matrix A₂ equals a sum of ranks of all submatrices A₂ₛ, and a rank of the private matrix B₁ equals a sum of ranks of all submatrices B_{1f}.

In Step S21, the rank-preserving secure 2-party matrix addition decomposition technique is used to split each of the private matrix A₂ and the private matrix B₁ into a plurality of submatrices. For a specific decomposition process, refer to Steps (1) to (4) in Step S11. Details are not described. Step S21 and Step S11 may be performed in parallel.

Step S22: The first computation participant and the second computation participant input a submatrix A₂ₛ and a submatrix B_{1f} of each second submatrix product combination respectively based on the secure two-party matrix multiplication protocol, to perform secure two-party matrix multiplication to obtain a second matrix multiplication result corresponding to the second submatrix product combination; and randomly split each second matrix multiplication result into a matrix V_{a2g} and a matrix V_{b2g} by using the obfuscation technique. Each submatrix of the private matrix A₂ and each second submatrix of the private matrix B₁ are randomly combined to obtain N₂×T₂ second submatrix product combinations, s=1, 2, . . . , and N₂; f=1, 2, . . . , and T₂; g=1, 2, . . . , and N₂×T₂. Step S22 and Step S12 may be performed in parallel.

Steps S22 corresponding to all second submatrix product combinations may be performed in parallel.

Step S23: Obtain the matrix Vₐ₂ based on the matrix V_{a2g} corresponding to each second submatrix product combination, and obtain the matrix V_{b2} based on the matrix V_{b2g} corresponding to each second submatrix product combination. Step S23 and Step S13 may be performed in parallel.

Step S3: The first computation participant performs private matrix multiplication to obtain a matrix Vₐ₀, where the matrix Vₐ₀ satisfies the following expression: Vₐ₀=A₁×A₂. Step S3 and Step S1 may be performed in parallel.

Step S4: The second computation participant performs private matrix multiplication to obtain a matrix V_{b0}, where the matrix V_{b0} satisfies the following expression: V_{b0}=B₁×B₂. Step S4 and Step S1 may be performed in parallel.

Step S5: The first computation participant performs local private computation on the matrix Vₐ₀, the matrix Vₐ₁, and the matrix Vₐ₂, to obtain a matrix Vₐ.

Step S6: The second computation participant performs local private computation on the matrix V_{b0}, the matrix V_{b1}, and the matrix V_{b2}, to obtain a matrix V_{b}.

Step S7: The first computation participant and the second computation participant send the matrix Vₐ and the matrix V_{b} respectively to a computation requester for secure two-party matrix hybrid multiplication, and the computation requester computes a privacy-preserving computation result.

The present disclosure uses the rank-preserving mechanism for matrix addition decomposition and the rank-preserving secure 2-party matrix addition decomposition technique that are proposed in Steps (1) to (4) in Step S11, to solve a prior-art problem that a security risk exists in two-matrix multiplication if an input matrix is full-rank. A basic secure two-party matrix multiplication protocol and the rank-preserving secure 2-party matrix addition decomposition technique are used, to implement hybrid multiplication in a multi-link 2PMP parallel computing mode. This solves a prior-art problem that data result leakage causes a potential risk to original data privacy.

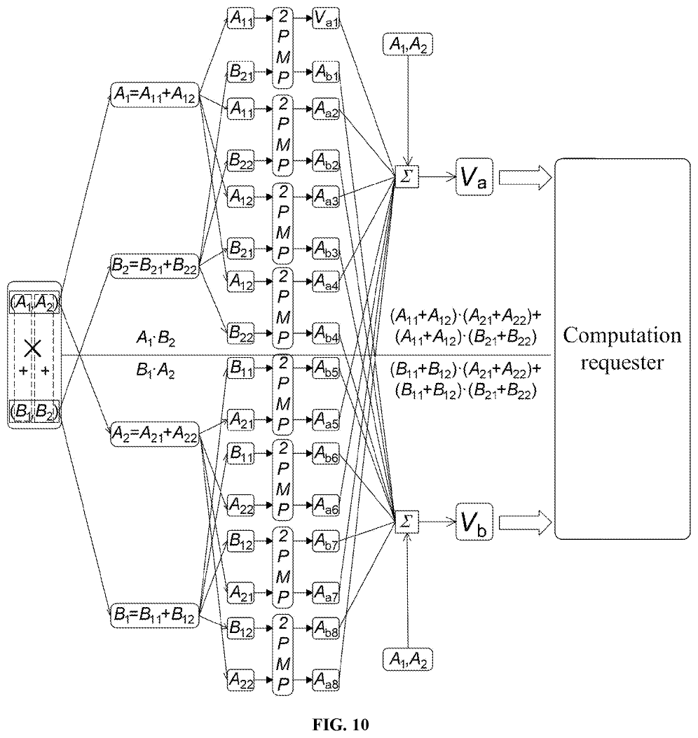

To help a person skilled in the art to better understand the privacy-preserving computation method that uses the rank-preserving secure 2-party matrix addition decomposition technique in this embodiment, as shown in FIG. 10, an example in which two submatrices are obtained through decomposition is specifically used for description.

Step 1: A participant node Alice correspondingly decomposes, based on the rank-preserving secure 2-party matrix addition decomposition technique (RS2MADT) and through Steps (1) to (4) of RS2MADT in Step S11, an initial input matrix A₁∈R^{m×t} into two non-full-column-rank submatrices A₁₁∈R^{m×t} and A₁₂∈R^{m×t} and stores, in a local private database, the submatrices as new input matrices obtained through random splitting; and a participant node Bob correspondingly decomposes, based on the rank-preserving secure 2-party matrix addition decomposition technique (RS2MADT) and through Steps (1) to (4) of RS2MADT in Step S11, an initial input matrix B₁∈R^{m×t} into two non-full-column-rank submatrices B₁₁∈R^{m×t} and B₁₂∈R^{m×t} and stores, in a local private database, the submatrices as new input matrices obtained through random splitting. Decomposition processes satisfy the following relationships: A₁+B₁=(A₁₁+A₁₂)+(B₁₁+B₁₂), A₁₁+A₁₂=A₁, and B₁₁+B₁₂=B₁. It can be learned from a rank-preserving property of matrix addition decomposition RMADM that ranks obtained before and after matrix decomposition satisfy the following relationships: r(A₁)=r(A₁₁)+r(A₁₂), and r(B₁)=r(B₁₁)+r(B₁₂). In addition, after rank reduction is performed, submatrices obtained after decomposition satisfy the following non-full-column-rank relationships: r(A₁₁)<t, r(A₁₂)<t, r(B₁₁)<t, and r(B₁₂)<t.

Step 2: In parallel with Step 1, the participant node Alice correspondingly decomposes, through Steps 1 to 5 of RS2MADT by using the addition decomposition technique, an initial input matrix A₂∈R^{t×n} into two non-full-column-rank submatrices A₂₁∈R^{t×n} and A₂₂∈R^{t×n} and stores, in a local private database, the submatrices as new input matrices obtained through random splitting; and the participant node Bob correspondingly decomposes, based on the addition decomposition technique through Steps 1 to 4 of RS2MADT, an initial input matrix B₂∈R^{t×n} into two non-full-column-rank submatrices B₂₁∈R^{t×n} and B₂₂∈R^{t×n} and stores, in a local private database, the submatrices as new input matrices obtained through random splitting. Decomposition processes satisfy the following relationships: A₂+B₂=(A₂₁+A₂₂)+(B₂₁+B₂₂), A₂₁+A₂₂=A₂, and B₂₁+B₂₂=B₂. It can be learned from a rank-preserving property of matrix addition decomposition RMADM that ranks obtained before and after matrix decomposition satisfy the following relationships: r(A₂)=r(A₂₁)+r(A₂₂) and r(B₂)=r(B₂₁)+r(B₂₂). In addition, after rank reduction is performed, submatrices obtained after decomposition satisfy the following non-full-row-rank relationships: r(A₂₁)<t, r(A₂₂)<t, r(B₂₁)<t, and r(B₂₂)<t.

Step 3: The participant node Alice performs private matrix multiplication Vₐ₀=A₁×A₂ locally, and stores the private matrix Vₐ₀∈R^{m×n} in the local private database after the computation is completed.

Step 4: In parallel with Step 3, the participant node Bob performs private matrix multiplication V_{b0}=B₁×B₂ locally, and stores the private matrix V_{b0}∈R^{m×n} in the local private database after the computation is completed.

Step 5: The participant node Alice and the participant node Bob respectively input, based on a secure two-party matrix multiplication protocol 2PMP, the private matrix A₁₁∈R^{m×t} and the private matrix B₂₁∈R^{t×n} that are obtained after conversion, to perform a first round of secure two-party matrix multiplication. After a first 2PMP module finishes computing, an intermediate computation result for this round is randomly split into matrices Vₐ₁, V_{b1}∈R^{m×n} by using an obfuscation technique SMDOT. Then, the matrices are respectively sent to the participant node Alice and the participant node Bob, where the two private output matrices satisfy a relationship of Vₐ₁+V_{b1}=_{A}×B₂₁=M₁.

Step 6: The participant node Alice and the participant node Bob respectively input, based on the secure two-party matrix multiplication protocol 2PMP, the private matrix A₁₁∈R^{m×t} and the private matrix B₂₂∈R^{t×n} that are obtained after conversion, to perform a second round of secure two-party matrix multiplication in parallel with Step 5. After a second 2PMP module finishes computing, an intermediate computation result for this round is randomly split into matrices Vₐ₂, V_{b2}∈R^{m×n} by using the obfuscation technique SMDOT. Then, the matrices are respectively sent to the participant node Alice and the participant node Bob, where the two private output matrices satisfy a relationship of Vₐ₂+V_{b2}=A₁×B₂₂=M₂.

Step 7: The participant node Alice and the participant node Bob respectively input, based on the secure two-party matrix multiplication protocol 2PMP, the private matrix A₁₂ ∈R^{m×t} and the private matrix B₂₁ ∈R^{t×n} that are obtained after conversion, to perform a third round of secure two-party matrix multiplication in parallel with Steps 5 and 6. After a third 2PMP module finishes computing, an intermediate computation result for this round is randomly split into matrices Vₐ₃, V_{b3}∈R^{t×n} by using the obfuscation technique SMDOT. Then, the matrices are respectively sent to the participant node Alice and the participant node Bob, where the two private output matrices satisfy a relationship of Vₐ₃+V_{b3}=A₁₂×B₂₁=M₃.

Step 8: The participant node Alice and the participant node Bob respectively input, based on the secure two-party matrix multiplication protocol 2PMP, the private matrix A₁₂ ∈R^{m×t} and the private matrix B₂₂∈R^{t×n} that are obtained after conversion, to perform a fourth round of secure two-party matrix multiplication in parallel with Steps 5 to 7. After a fourth 2PMP module finishes computing, an intermediate computation result for this round is randomly split into matrices Vₐ₄, V_{b4}∈R^{m×n} by using the obfuscation technique SMDOT. Then, the matrices are respectively sent to the participant node Alice and the participant node Bob, where the two private output matrices satisfy a relationship of Vₐ₄+V_{b4}=A₁₂×B₂₂=M₄.

Step 9: The participant node Alice and the participant node Bob respectively input, based on the secure two-party matrix multiplication protocol 2PMP, the private matrix A₂₁∈R^{m×t} and the private matrix B₁₁∈R^{t×n} that are obtained after conversion, to perform a fifth round of secure two-party matrix multiplication in parallel with Steps 5 to 8. After a fifth 2PMP module finishes computing, an intermediate computation result for this round is randomly split into matrices Vₐ₅, V_{b5}∈R^{m×n} by using the obfuscation technique SMDOT. Then, the matrices are respectively sent to the participant node Alice and the participant node Bob, where the two private output matrices satisfy a relationship of Vₐ₅+V_{b5}=B₁₁×A₂₁=M₅.

Step 10: The participant node Alice and the participant node Bob respectively input, based on the secure two-party matrix multiplication protocol 2PMP, the private matrix A₂₂∈R^{m×t} and the private matrix B₁₁∈R^{t×n} that are obtained after conversion, to perform a sixth round of secure two-party matrix multiplication in parallel with Steps 5 to 9. After a sixth 2PMP module finishes computing, an intermediate computation result for this round is randomly split into matrices Vₐ₆, V_{b6}∈R^{m×n} by using the obfuscation technique SMDOT. Then, the matrices are respectively sent to the participant node Alice and the participant node Bob, where the two private output matrices satisfy a relationship of Vₐ₆+V_{b6}=B₁₁×A₂₂=M₆.

Step 11: The participant node Alice and the participant node Bob respectively input, based on the secure two-party matrix multiplication protocol 2PMP, the private matrix A₂₁∈R^{m×t} and the private matrix B₁₂∈R^{t×n} that are obtained after conversion, to perform a seventh round of secure two-party matrix multiplication in parallel with Steps 5 to 10. After a seventh 2PMP module finishes computing, an intermediate computation result for this round is randomly split into matrices Vₐ₇, V_{b7}∈R^{m×n} by using the obfuscation technique SMDOT. Then, the matrices are respectively sent to the participant node Alice and the participant node Bob, where the two private output matrices satisfy a relationship of Vₐ₇+V_{b7}=B₁₂×A₂₁=M₇.

Step 12: The participant node Alice and the participant node Bob respectively input, based on the secure two-party matrix multiplication protocol 2PMP, the private matrix A₂₂∈R^{m×t} and the private matrix B₁₂∈R^{t×n} that are obtained after conversion, to perform an eighth round of secure two-party matrix multiplication in parallel with Steps 5 to 11. After an eighth 2PMP module finishes computing, an intermediate computation result for this round is randomly split into matrices Vₐ₈, V_{b8}∈R^{m×n} by using the obfuscation technique SMDOT. Then, the matrices are respectively sent to the participant node Alice and the participant node Bob, where the two private output matrices satisfy a relationship of Vₐ₈+V_{b8}=B₁₂×A₂₂=M₈.

Step 13: The participant node Alice secretly summarizes the computation result Vₐ₀ obtained in Step 3 and intermediate computation results Vₐ₁, Vₐ₂, Vₐ₃, Vₐ₄, Vₐ₅, Vₐ₆, Vₐ₇, Vₐ₈ obtained through random splitting performed based on the 2PMP matrix multiplication protocol in parallel in the foregoing eight rounds in Steps 5 to 12, and performs private computation Vₐ=Σ_{0≤i≤8}[Vₐ₁]=Vₐ₀+Vₐ₁+Vₐ₂+Vₐ₃+Vₐ₄+Vₐ₅+Vₐ₆+Vₐ₇+Vₐ₈ locally, where Vₐ∈R^{m×n}.

Step 14: The participant node Bob secretly summarizes the computation result V_{b0} obtained in Step 4 and the intermediate computation results V_{b1}, V_{b2}, V_{b3}, V_{b4}, V_{b5}, V_{b6}, V_{b7}, V_{b8} obtained through random splitting performed based on the 2PMP matrix multiplication protocol in parallel in the foregoing eight rounds in Steps 5 to 12, and performs private computation V_{b}=Σ_{0≤j≤8}[V_{bj}]=V_{b0}+V_{b1}+V_{b2}+V_{b3}+V_{b4}+V_{b5}+V_{b6}+V_{b7}+V_{b8} locally, where V_{b}∈R^{m×n}.

Step 15: The participant node Alice and the participant node Bob respectively send, to a computation requester for secure two-party matrix hybrid multiplication, private matrices Vₐ, V_{b}∈R^{m×n} that are obtained in Steps 13 and 14 by summarizing intermediate computation results. The computation requester obtains a final computation result (A₁+B₁)×(A₂+B₂)=Vₐ+V_{b} through summarization. Apparently, it can be readily verified that:

$${V}_{a} + {V}_{b} = {\sum }_{0 \leq i \leq 8} [ {V}_{a i} ] + {\sum }_{0 \leq j \leq 8} [ {V}_{b j} ] = ( {V}_{a 0} + {V}_{a 1} + {V}_{a 2} + {V}_{a 3} + {V}_{a 4} + {V}_{a 5} + {V}_{a 6} + {V}_{a 7} + {V}_{a 8} ) + ( {V}_{b 0} + {V}_{b 1} + {V}_{b 2} + {V}_{b 3} + {V}_{b 4} + {V}_{b 5} + {V}_{b 6} + {V}_{b 7} + {V}_{b 8} ) = ( {V}_{a 0} + {V}_{b 0} ) + ( {V}_{a 1} + {V}_{b 1} ) + ( {V}_{a 2} + {V}_{b 2} ) + ( {V}_{a 3} + {V}_{b 3} ) + ( {V}_{a 4} + {V}_{b 4} ) + ( {V}_{a 5} + {V}_{b 5} ) + ( {V}_{a 6} + {V}_{b 6} ) + ( {V}_{a 7} + {V}_{b 7} ) + ( {V}_{a 8} + {V}_{b 8} ) = {A}_{1} {A}_{2} + {B}_{1} {B}_{2} + {A}_{11} {B}_{21} + {A}_{11} {B}_{22} + {A}_{12} {B}_{21} + {A}_{12} {B}_{22} + {B}_{11} {A}_{21} + {B}_{11} {A}_{22} + {B}_{12} {A}_{21} + {B}_{12} {A}_{22} = ( {A}_{11} + {A}_{12} ) ( {A}_{21} + {A}_{22} ) + ( {B}_{11} + {B}_{12} ) ( {B}_{21} + {B}_{22} ) + ( {A}_{11} + {A}_{12} ) ( {B}_{21} + {B}_{22} ) + ( {B}_{11} + {B}_{12} ) ( {A}_{21} + {A}_{22} ) = {A}_{1} {B}_{2} + {B}_{1} {A}_{2} + {A}_{1} {A}_{2} + {B}_{1} {B}_{2} = ( {A}_{1} + {B}_{1} ) \times ( {A}_{2} + {B}_{2} ) .$$

In the specific example of obtaining two submatrices through decomposition in this embodiment, the present disclosure proposes an end-to-end parallel hybrid multiplication solution for a result leakage environment based on the basic secure two-party matrix multiplication protocol 2PMP. In addition, computation in Steps 3 to 12 are performed in parallel. This solves prior-art problems of high communication overheads and a large ciphertext computation space that are caused due to use of homomorphic encryption and oblivious transfer technologies. In Steps 1 and 2 in the specific example, the basic secure two-party matrix multiplication protocol and the rank-preserving secure 2-party matrix addition decomposition technique are used, to implement hybrid multiplication in an eight-link 2PMP parallel computing mode. This solves a prior-art problem that data result leakage causes a potential risk to original data privacy. Steps 2 to 12 in the specific example are key steps for ensuring stable precision of secure two-party matrix hybrid multiplication. A key to ensuring computation precision in the present disclosure is use of the secure two-party matrix multiplication protocol 2PMP that supports computation with precision up to a 64-bit floating number. This solves a prior-art problem that numerical precision of floating point computation is inadequate because a quantity of ciphertext digits is fixed.

The following describes advantages of the present disclosure with reference to the privacy-preserving computation methods for secure two-party matrix hybrid multiplication in Embodiment 1 and Embodiment 2.
(1) The present disclosure proposes, based on the basic secure two-party matrix multiplication protocol 2PMP, two end-to-end parallel hybrid multiplication solutions that are applicable to a semi-honest environment and a result leakage environment respectively. This solves prior-art problems of high communication overheads and a large ciphertext computation space that are caused due to use of homomorphic encryption and oblivious transfer technologies. In addition, this implements a secure two-party matrix hybrid multiplication solution in a dual-link parallel mode for a scenario that is independent of a third-party cloud service provider and that has high security requirements, and implements a secure two-party matrix hybrid multiplication solution in an eight-link parallel mode for a scenario with low security requirements.
(2) The present disclosure uses the rank-preserving mechanism for matrix addition decomposition and the rank-preserving secure 2-party matrix addition decomposition technique that are proposed for the first time, to solve a prior-art problem that a security risk exists in two-matrix multiplication if an input matrix is full-rank. In this way, a random decomposition method for independently control a rank of an input matrix is implemented.
(3) The present disclosure uses the basic secure two-party matrix multiplication protocol and the rank-preserving secure 2-party matrix addition decomposition technique to implement a hybrid multiplication solution in an eight-link 2PMP parallel computing mode. This solves a prior-art problem that data result leakage causes a potential risk to original data privacy, and implements a secure two-party matrix hybrid multiplication protocol in an efficient parallel mode for a privacy leakage environment.
(4) Based on a random obfuscation encryption concept with reference to the high-precision secure two-party multiplication protocol 2PMP, the present disclosure constructs two secure two-party matrix hybrid multiplication protocols for different scenarios. The 2PMP protocol can support precision up to a 64-bit floating point. Therefore, the protocol is not limited to integer-type matrix computation. Compared with obfuscation circuit and homomorphic encryption solutions that can be used to process only fixed-length decimals and integers, secure matrix multiplication is applicable to more scenarios. In addition, numerical computation precision of a computation result obtained through secure matrix multiplication is at a same order of magnitude as that of a computation result obtained by using a centralized computing method.

### Embodiment 3

This embodiment provides a privacy-preserving computation system for secure two-party matrix hybrid multiplication, involving two computation participants. A first computation participant has a private matrix A₁ and a private matrix A₂, and a second computation participant has a private matrix B₁ and a private matrix B₂. The system includes a first matrix multiplication module 100, a second matrix multiplication module 200, a first local private computation module 300, a second local private computation module 400, a first matrix computation module 500, a second matrix computation module 600, and a privacy-preserving computation result output module 700.

The first matrix multiplication module 100 is configured to: be used by the first computation participant and the second computation participant to input the private matrix A₁ and the private matrix B₂ respectively based on a secure two-party matrix multiplication protocol, to perform secure two-party matrix multiplication to obtain a first matrix multiplication result; randomly split the first matrix multiplication result into a matrix Vₐ₁ and a matrix V_{b1} by using an obfuscation technique; and send the matrix Vₐ₁ and the matrix V_{b1} to the first computation participant and the second computation participant respectively, where the matrix Vₐ₁ and the matrix V_{b1} satisfy an expression of Vₐ₁+V_{b1}=A₁×B₂.

The second matrix multiplication module 200 is configured to: be used by the first computation participant and the second computation participant to input the private matrix A₂ and the private matrix B₁ respectively based on the secure two-party matrix multiplication protocol, to perform secure two-party matrix multiplication to obtain a second matrix multiplication result; randomly split the second matrix multiplication result into a matrix Vₐ₂ and a matrix V_{b2} by using the obfuscation technique; and send the matrix Vₐ₂ and the matrix V_{b2} to the first computation participant and the second computation participant respectively, where the matrix Vₐ₂ and the matrix V_{b2} satisfy an expression of Vₐ₂+V_{b2}=B₁×A₂.

The first local private computation module 300 is configured to be used by the first computation participant to perform private matrix multiplication to obtain a matrix Vₐ₀, where the matrix Vₐ₀ satisfies the following expression: Vₐ₀=A₁×A₂.

The second local private computation module 400 is configured to be used by the second computation participant to perform private matrix multiplication to obtain a matrix V_{b0}, where the matrix V_{b0} satisfies the following expression: V_{b0}=B₁×B₂.

The first matrix computation module 500 is configured to be used by the first computation participant to perform local private computation on the matrix Vₐ₀, the matrix Vₐ₁, and the matrix Vₐ₂, to obtain a matrix Va.

The second matrix computation module 600 is configured to be used by the second computation participant to perform local private computation on the matrix V_{b0}, the matrix V_{b1}, and the matrix V_{b2}, to obtain a matrix V_{b}.

The privacy-preserving computation result output module 700 is configured to: be used by the first computation participant and the second computation participant to send the matrix Vₐ and the matrix V_{b} respectively to a computation requester for secure two-party matrix hybrid multiplication, where the computation requester computes a privacy-preserving computation result.

The first matrix multiplication module specifically includes a first matrix decomposition submodule, a first submodule for secure two-party matrix multiplication between submatrices, and a first matrix fusion submodule.

The first matrix decomposition submodule is configured to: be used by the first computation participant to split the private matrix A₁ into a plurality of submatrices by using a rank-preserving secure 2-party matrix addition decomposition technique; and be used by the second computation participant to split the private matrix B₂ into a plurality of submatrices by using the rank-preserving secure 2-party matrix addition decomposition technique. The private matrix A₁=A₁₁+A₁₂+A₁ᵢ+ . . . +A_{1N}_{₁}, the private matrix B₂=B₂₁+B₂₂+B₂ⱼ+ . . . +B_{2T}_{₁}, a rank of the private matrix A₁ equals a sum of ranks of all submatrices A₁₁, and a rank of the private matrix B₂ equals a sum of ranks of all submatrices B₂ⱼ.

The first submodule for secure two-party matrix multiplication between submatrices is configured to: be used by the first computation participant and the second computation participant to input a submatrix A₁ᵢ and a submatrix B₂ⱼ of each first submatrix product combination respectively based on the secure two-party matrix multiplication protocol, to perform secure two-party matrix multiplication to obtain a first matrix multiplication result corresponding to the first submatrix product combination; and randomly split each first matrix multiplication result into a matrix Vₐ₁ₑ and a matrix V_{b1e} by using the obfuscation technique. Each submatrix of the private matrix A₁ and each submatrix of the private matrix B₂ are randomly combined to obtain N₁×T₁ first submatrix product combinations, i=1, 2, . . . , and N₁; j=1, 2, . . . , and T₁; e=1, 2, . . . , and N₁×T₁.

The first matrix fusion submodule is configured to: obtain the matrix Vₐ₁ based on the matrix Vₐ₁ₑ corresponding to each first submatrix product combination, and obtain the matrix V_{b1} based on the matrix V_{b1e} corresponding to each first submatrix product combination.

The second matrix multiplication module specifically includes a second matrix decomposition submodule, a second submodule for secure two-party matrix multiplication between submatrices, and a second matrix fusion submodule.

The second matrix decomposition submodule is configured to: be used by the first computation participant to split the private matrix A₂ into a plurality of submatrices by using the rank-preserving secure 2-party matrix addition decomposition technique; and be used by the second computation participant to split the private matrix B₁ into a plurality of submatrices by using the rank-preserving secure 2-party matrix addition decomposition technique. The private matrix A₂=A₂₁+A₂₂+A₂ₛ+ . . . +A_{2N}_{₂}, the private matrix B₁=B₁₁+B₁₂+B_{1f}+ . . . +B_{1T}_{₂}, a rank of the private matrix A₂ equals a sum of ranks of all submatrices A₂ₛ, and a rank of the private matrix B₁ equals a sum of ranks of all submatrices B_{1f}.

The second submodule for secure two-party matrix multiplication between submatrices is configured to: be used by the first computation participant and the second computation participant to input a submatrix A₂ₛ and a submatrix B_{1f} of each second submatrix product combination respectively based on the secure two-party matrix multiplication protocol, to perform secure two-party matrix multiplication to obtain a second matrix multiplication result corresponding to the second submatrix product combination; and randomly split each second matrix multiplication result into a matrix V_{a2g} and a matrix V_{b2g} by using the obfuscation technique. Each submatrix of the private matrix A₂ and each submatrix of the private matrix B₂ are randomly combined to obtain N₂×T₂ second submatrix product combinations, s=1, 2, . . . , and N₂; f=1, 2, . . . , and T₂; g=1, 2, . . . , and N₂×T₂.

The second matrix fusion submodule is configured to: obtain the matrix Vₐ₂ based on the matrix V_{a2g} corresponding to each second submatrix product combination, and obtain the matrix V_{b2} based on the matrix V_{b2g} corresponding to each second submatrix product combination.

The first matrix decomposition submodule specifically includes a first matrix decomposition unit and a second matrix decomposition unit.

The first matrix decomposition unit is configured to be used by the first computation participant to split the private matrix A₁ into a plurality of submatrices by using the rank-preserving secure 2-party matrix addition decomposition technique.

The second matrix decomposition unit is configured to be used by the second computation participant to split the private matrix B₂ into a plurality of submatrices by using the rank-preserving secure 2-party matrix addition decomposition technique.

The first matrix decomposition unit specifically includes a determining subunit, an elementary transformation subunit, a matrix decomposition subunit, and an inverse transformation subunit.

The determining subunit is configured to: be used by the first computation participant to determine the rank of the private matrix A₁; determine whether the rank of the private matrix A₁ equals 1; and if the rank of the private matrix A₁ equals 1, skip performing matrix decomposition on the private matrix A₁.

The elementary transformation subunit is configured to: if the rank of the private matrix A₁ does not equal 1, perform elementary row transformation on the private matrix A₁ to obtain a row echelon matrix and a non-singular matrix Pₐ of the private matrix A₁, and perform elementary column transformation on the row echelon matrix to obtain a canonical matrix F and a non-singular matrix Qₐ of the private matrix A₁.

The matrix decomposition subunit is configured to: decompose the canonical matrix F into N₁ canonical submatrices based on the rank of the private matrix A₁ and a preset matrix decomposition quantity of the private matrix A₁ in a manner of performing row/column partitioning without overlapping. Each canonical submatrix includes a sparse diagonal matrix and a null matrix, and the sparse diagonal matrix consists of elements 0 and 1.

The inverse transformation subunit is configured to perform invertible transformation on each canonical submatrix based on the non-singular matrix Pₐ and the non-singular matrix Qₐ, to obtain N₁ submatrices A₁ᵢ.

The second matrix decomposition unit has a same structure as the first matrix decomposition unit, but an object processed by the second matrix decomposition unit is the private matrix B₂.

### Embodiment 4

This embodiment provides an electronic device, including a memory and a processor. The memory is configured to store a computer program, and the processor runs the computer program so that the electronic device performs the privacy-preserving computation method for secure two-party matrix hybrid multiplication provided in Embodiment 1 or Embodiment 2.

Alternatively, the foregoing electronic device may be a server.

In addition, an embodiment of the present disclosure further provides a computer-readable storage medium, storing a computer program. When the computer program is run on a processor, the privacy-preserving computation method for secure two-party matrix hybrid multiplication provided in Embodiment 1 or Embodiment 2 is performed.

Embodiments of the present disclosure may be provided as methods, systems, or computer program products. Therefore, the present disclosure may use a form of hardware only embodiments, software only embodiments, or embodiments with a combination of software and hardware. Moreover, the present disclosure may use a form of a computer program product that is implemented on one or more computer-usable storage media (including but not limited to a magnetic disk memory, a CD-ROM, an optical memory, and the like) that include computer-usable program code.

The present disclosure is described with reference to the flowcharts and/or block diagrams of the method, the device (system), and the computer program product according to the embodiments of the present disclosure. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of another programmable data processing device to generate a machine, so that the instructions executed by a computer or a processor of another programmable data processing device generate an apparatus for implementing a specific function in one or more processes in the flowcharts and/or in one or more blocks in the block diagrams.

The description of each example in this specification focuses on a difference of the example from other embodiments. The same or similar parts of these examples may refer to each other. Since the system disclosed in an embodiment corresponds to the method disclosed in an embodiment, the description is relatively simple, and for related contents, references can be made to the description of the method.

Particular examples are used herein for illustration of principles and implementations of the present disclosure. The descriptions of the above embodiments are merely used for assisting in understanding the method of the present disclosure and its core ideas. In addition, those of ordinary skill in the art can make various modifications in terms of particular implementations and the scope of application in accordance with the ideas of the present disclosure. In conclusion, the content of the description shall not be construed as limitations to the present disclosure.

What is claimed is:

1. A privacy-preserving computation method for secure two-party matrix hybrid multiplication, involving two computation participants, wherein a first computation participant has a private matrix A₁ and a private matrix A₂, and a second computation participant has a private matrix B₁ and a private matrix B₂; and the method comprises:
inputting, by the first computation participant and the second computation participant, the private matrix A₁ and the private matrix B₂ respectively based on a secure two-party matrix multiplication protocol, to perform secure two-party matrix multiplication to obtain a first matrix multiplication result; randomly splitting the first matrix multiplication result into a matrix Vₐ₁ and a matrix V_{b1} by using an obfuscation technique; and sending the matrix Vₐ₁ and the matrix V_{b1} to the first computation participant and the second computation participant respectively, wherein the matrix Vₐ₁ and the matrix V_{b1} satisfy an expression of Vₐ₁+V_{b1}=A₁×B₂;
inputting, by the first computation participant and the second computation participant, the private matrix A₂ and the private matrix B₁ respectively based on the secure two-party matrix multiplication protocol, to perform secure two-party matrix multiplication to obtain a second matrix multiplication result; randomly splitting the second matrix multiplication result into a matrix Vₐ₂ and a matrix V_{b2} by using the obfuscation technique; and sending the matrix Vₐ₂ and the matrix V_{b2} to the first computation participant and the second computation participant respectively, wherein the matrix Vₐ₂ and the matrix V_{b2} satisfy an expression of Vₐ₂+V_{b2}=B₁×A₂;
performing, by the first computation participant, private matrix multiplication to obtain a matrix Vₐ₀, wherein the matrix Vₐ₀ satisfies the following expression: Vₐ₀=A₁×A₂;
performing, by the second computation participant, private matrix multiplication to obtain a matrix V_{b0}, wherein the matrix V_{b0} satisfies the following expression: V_{b0}=B₁×B₂;
performing, by the first computation participant, local private computation on the matrix Vₐ₀, the matrix Vₐ₁, and the matrix Vₐ₂, to obtain a matrix Vₐ;
performing, by the second computation participant, local private computation on the matrix V_{b0}, the matrix V_{b1}, and the matrix V_{b2}, to obtain a matrix V_{b}; and
sending, by the first computation participant and the second computation participant, the matrix Vₐ and the matrix V_{b} respectively to a computation requester for secure two-party matrix hybrid multiplication, wherein the computation requester computes a privacy-preserving computation result.

2. The method according to claim 1, wherein the inputting, by the first computation participant and the second computation participant, the private matrix A₁ and the private matrix B₂ respectively based on a secure two-party matrix multiplication protocol, to perform secure two-party matrix multiplication to obtain a first matrix multiplication result; and randomly splitting the first matrix multiplication result into a matrix Vₐ₁ and a matrix V_{b1} by using an obfuscation technique specifically comprises:
splitting, by the first computation participant, the private matrix A₁ into a plurality of submatrices by using a rank-preserving secure 2-party matrix addition decomposition technique;
and splitting, by the second computation participant, the private matrix B₂ into a plurality of submatrices by using the rank-preserving secure 2-party matrix addition decomposition technique, wherein the private matrix A₁=A₁₁+A₁₂+A₁ᵢ+ . . . +A_{1N}_{₁}, the private matrix B₂=B₂₁+B₂₂+B₂ⱼ+ . . . +B_{2T}_{₁}, a rank of the private matrix A₁ equals a sum of ranks of all submatrices A₁ᵢ, and a rank of the private matrix B₂ equals a sum of ranks of all submatrices B₂ⱼ;
inputting, by the first computation participant and the second computation participant, a submatrix A₁ᵢ and a submatrix B₂ⱼ of each first submatrix product combination respectively based on the secure two-party matrix multiplication protocol, to perform secure two-party matrix multiplication to obtain a first matrix multiplication result corresponding to the first submatrix product combination; and randomly splitting each first matrix multiplication result into a matrix Vₐ₁ₑ and a matrix V_{b1e} by using the obfuscation technique, wherein each submatrix of the private matrix A₁ and each submatrix of the private matrix B₂ are randomly combined to obtain N₁×T₁ first submatrix product combinations, i=1, 2, . . . , and N₁; j=1, 2, . . . , and T₁; e=1, 2, . . . , and N₁×T₁; and
obtaining the matrix Vₐ₁ based on the matrix Vₐ₁ₑ corresponding to each first submatrix product combination, and obtaining the matrix V_{b1} based on the matrix V_{b1e} corresponding to each first submatrix product combination.

3. The method according to claim 2, wherein the inputting, by the first computation participant and the second computation participant, the private matrix A₂ and the private matrix B₁ respectively based on the secure two-party matrix multiplication protocol, to perform secure two-party matrix multiplication to obtain a second matrix multiplication result; and randomly splitting the second matrix multiplication result into a matrix Vₐ₂ and a matrix V_{b2} by using the obfuscation technique specifically comprises:
splitting, by the first computation participant, the private matrix A₂ into a plurality of submatrices by using the rank-preserving secure 2-party matrix addition decomposition technique; and splitting, by the second computation participant, the private matrix B₁ into a plurality of submatrices by using the rank-preserving secure 2-party matrix addition decomposition technique, wherein the private matrix A₂=A₂₁+A₂₂+A₂ₛ+ . . . +A_{2N}_{₂}, the private matrix B₁=B₁₁+B₁₂+B_{1f}+ . . . +B_{1T}_{₂}, a rank of the private matrix A₂ equals a sum of ranks of all submatrices A₂ₛ, and a rank of the private matrix B₁ equals a sum of ranks of all submatrices B_{1f};
inputting, by the first computation participant and the second computation participant, a submatrix A₂ₛ and a submatrix B_{1f} of each second submatrix product combination respectively based on the secure two-party matrix multiplication protocol, to perform secure two-party matrix multiplication to obtain a second matrix multiplication result corresponding to the second submatrix product combination; and randomly splitting each second matrix multiplication result into a matrix V_{a2g} and a matrix V_{b2g} by using the obfuscation technique, wherein each submatrix of the private matrix A₂ and each second submatrix of the private matrix B₁ are randomly combined to obtain N₂×T₂ second submatrix product combinations, s=1, 2, . . . , and N₂; f=1, 2, . . . and T₂; g=1, 2, . . . , and N₂×T₂; and
obtaining the matrix Vₐ₂ based on the matrix V_{a2g} corresponding to each second submatrix product combination, and obtaining the matrix V_{b2} based on the matrix V_{b2g} corresponding to each second submatrix product combination.

4. The method according to claim 2, wherein the splitting, by the first computation participant, the private matrix A₁ into a plurality of submatrices by using a rank-preserving secure 2-party matrix addition decomposition technique specifically comprises:
determining, by the first computation participant, the rank of the private matrix A₁; determining whether the rank of the private matrix A₁ equals 1; and if the rank of the private matrix A₁ equals 1, skipping performing matrix decomposition on the private matrix A₁; or
if the rank of the private matrix A₁ does not equal 1, performing elementary row transformation on the private matrix A₁ to obtain a row echelon matrix and a non-singular matrix Pₐ of the private matrix A₁, and performing elementary column transformation on the row echelon matrix to obtain a canonical matrix F and a non-singular matrix Qₐ of the private matrix A₁;
decomposing the canonical matrix F into N₁ canonical submatrices based on the rank of the private matrix A₁ and a preset matrix decomposition quantity of the private matrix A₁ in a manner of performing row/column partitioning without overlapping, wherein each canonical submatrix comprises a sparse diagonal matrix and a null matrix, and the sparse diagonal matrix consists of elements 0 and 1; and
performing invertible transformation on each canonical submatrix based on the non-singular matrix Pₐ and the non-singular matrix Qₐ, to obtain N₁ submatrices Au.

5. A privacy-preserving computation system for secure two-party matrix hybrid multiplication, involving two computation participants, wherein a first computation participant has a private matrix A₁ and a private matrix A₂, and a second computation participant has a private matrix B₁ and a private matrix B₂; and the system comprises:
a first matrix multiplication module, configured to: be used by the first computation participant and the second computation participant to input the private matrix A₁ and the private matrix B₂ respectively based on a secure two-party matrix multiplication protocol, to perform secure two-party matrix multiplication to obtain a first matrix multiplication result; randomly split the first matrix multiplication result into a matrix Vₐ₁ and a matrix V_{b1} by using an obfuscation technique; and send the matrix Vₐ₁ and the matrix V_{b1} to the first computation participant and the second computation participant respectively, wherein the matrix Vₐ₁ and the matrix V_{b1} satisfy an expression of Vₐ₁+V_{b1}=A₁×B₂;
a second matrix multiplication module, configured to: be used by the first computation participant and the second computation participant to input the private matrix A₂ and the private matrix B₁ respectively based on the secure two-party matrix multiplication protocol, to perform secure two-party matrix multiplication to obtain a second matrix multiplication result; randomly split the second matrix multiplication result into a matrix Vₐ₂ and a matrix V_{b2} by using the obfuscation technique; and send the matrix Vₐ₂ and the matrix V_{b2} to the first computation participant and the second computation participant respectively, wherein the matrix Vₐ₂ and the matrix V_{b2} satisfy an expression of Vₐ₂+V_{b2}=B₁×A₂;
a first local private computation module, configured to be used by the first computation participant to perform private matrix multiplication to obtain a matrix Vₐ₀, wherein the matrix Vₐ₀ satisfies the following expression: Vₐ₀=A₁×A₂;
a second local private computation module, configured to be used by the second computation participant to perform private matrix multiplication to obtain a matrix V_{b0}, wherein the matrix V_{b0} satisfies the following expression: V_{b0}=B₁×B₂;
a first matrix computation module, configured to be used by the first computation participant to perform local private computation on the matrix Vₐ₀, the matrix Vₐ₁, and the matrix Vₐ₂, to obtain a matrix Vₐ;
a second matrix computation module, configured to be used by the second computation participant to perform local private computation on the matrix V_{b0}, the matrix V_{b1}, and the matrix V_{b2} to obtain a matrix V_{b}; and
a privacy-preserving computation result output module, configured to: be used by the first computation participant and the second computation participant to send the matrix Vₐ and the matrix V_{b} respectively to a computation requester for secure two-party matrix hybrid multiplication, wherein the computation requester computes a privacy-preserving computation result.

6. The system according to claim 5, wherein the first matrix multiplication module specifically comprises:
a first matrix decomposition submodule, configured to: be used by the first computation participant to split the private matrix A₁ into a plurality of submatrices by using a rank-preserving secure 2-party matrix addition decomposition technique; and be used by the second computation participant to split the private matrix B₂ into a plurality of submatrices by using the rank-preserving secure 2-party matrix addition decomposition technique, wherein the private matrix A₁=A₁₁+A₁₂+A₁ᵢ+ . . . +A_{1N}_{₁}, the private matrix B₂=B₂₁+B₂₂+B₂ⱼ+ . . . +B_{2T}_{₁}, a rank of the private matrix A₁ equals a sum of ranks of all submatrices A₁₁, and a rank of the private matrix B₂ equals a sum of ranks of all submatrices B₂ⱼ;
a first submodule for secure two-party matrix multiplication between submatrices, configured to: be used by the first computation participant and the second computation participant to input a submatrix A₁, and a submatrix B₂ⱼ of each first submatrix product combination respectively based on the secure two-party matrix multiplication protocol, to perform secure two-party matrix multiplication to obtain a first matrix multiplication result corresponding to the first submatrix product combination; and randomly split each first matrix multiplication result into a matrix Vₐ₁ₑ and a matrix V_{b1e} by using the obfuscation technique, wherein each submatrix of the private matrix A₁ and each submatrix of the private matrix B₂ are randomly combined to obtain N₁×T₁ first submatrix product combinations, i=1, 2, . . . , and N₁; j=1, 2, . . . , and T₁; e=1, 2, . . . , and N₁×T₁; and
a first matrix fusion submodule, configured to: obtain the matrix Vₐ₁ based on the matrix Vₐ₁ₑ corresponding to each first submatrix product combination, and obtain the matrix V_{b1} based on the matrix V_{b1e} corresponding to each first submatrix product combination.

7. The system according to claim 6, wherein the second matrix multiplication module specifically comprises:
a second matrix decomposition submodule, configured to: be used by the first computation participant to split the private matrix A₂ into a plurality of submatrices by using the rank-preserving secure 2-party matrix addition decomposition technique; and be used by the second computation participant to split the private matrix B₁ into a plurality of submatrices by using the rank-preserving secure 2-party matrix addition decomposition technique, wherein the private matrix A₂=A₂₁+A₂₂+A₂ₛ+ . . . +A_{2N}_{₂}, the private matrix B₁=B₁₁+B₁₂+B_{1f}+ . . . +B_{1T}_{₂}, a rank of the private matrix A₂ equals a sum of ranks of all submatrices A₂ₛ, and a rank of the private matrix B₁ equals a sum of ranks of all submatrices B_{1f};
a second submodule for secure two-party matrix multiplication between submatrices, configured to: be used by the first computation participant and the second computation participant to input a submatrix A₂ₛ and a submatrix B_{1f} of each second submatrix product combination respectively based on the secure two-party matrix multiplication protocol, to perform secure two-party matrix multiplication to obtain a second matrix multiplication result corresponding to the second submatrix product combination; and randomly split each second matrix multiplication result into a matrix V_{a2g} and a matrix V_{b2g} by using the obfuscation technique, wherein each submatrix of the private matrix A₂ and each submatrix of the private matrix B₂ are randomly combined to obtain N₂×T₂ second submatrix product combinations, s=1, 2, . . . , and N₂; f=1, 2, . . . , and T₂; g=1, 2, . . . , and N₂×T₂; and
a second matrix fusion submodule, configured to: obtain the matrix Vₐ₂ based on the matrix V_{a2g} corresponding to each second submatrix product combination, and obtain the matrix V_{b2} based on the matrix V_{b2g} corresponding to each second submatrix product combination.

8. The system according to claim 6, wherein the first matrix decomposition submodule specifically comprises a first matrix decomposition unit and a second matrix decomposition unit, wherein
the first matrix decomposition unit is configured to be used by the first computation participant to split the private matrix A₁ into a plurality of submatrices by using the rank-preserving secure 2-party matrix addition decomposition technique; and
the second matrix decomposition unit is configured to be used by the second computation participant to split the private matrix B₂ into a plurality of submatrices by using the rank-preserving secure 2-party matrix addition decomposition technique; wherein
the first matrix decomposition unit specifically comprises:
a determining subunit, configured to: be used by the first computation participant to determine the rank of the private matrix A₁; determine whether the rank of the private matrix A₁ equals 1; and if the rank of the private matrix A₁ equals 1, skip performing matrix decomposition on the private matrix A₁;
an elementary transformation subunit, configured to: if the rank of the private matrix A₁ does not equal 1, perform elementary row transformation on the private matrix A₁ to obtain a row echelon matrix and a non-singular matrix Pₐ of the private matrix A₁, and perform elementary column transformation on the row echelon matrix to obtain a canonical matrix F and a non-singular matrix Qₐ of the private matrix A₁;
a matrix decomposition subunit, configured to: decompose the canonical matrix F into N₁ canonical submatrices based on the rank of the private matrix A₁ and a preset matrix decomposition quantity of the private matrix A₁ in a manner of performing row/column partitioning without overlapping, wherein each canonical submatrix comprises a sparse diagonal matrix and a null matrix, and the sparse diagonal matrix consists of elements 0 and 1; and
an inverse transformation subunit, configured to perform invertible transformation on each canonical submatrix based on the non-singular matrix Pa and the non-singular matrix Qₐ, to obtain N₁ submatrices A₁ᵢ.

9. A computer-readable storage medium, storing a computer program, wherein when the computer program is run on a processor, the privacy-preserving computation method for secure two-party matrix hybrid multiplication according to claim 1 is performed.

10. The computer-readable storage medium according to claim 9, wherein the inputting, by the first computation participant and the second computation participant, the private matrix A₁ and the private matrix B₂ respectively based on a secure two-party matrix multiplication protocol, to perform secure two-party matrix multiplication to obtain a first matrix multiplication result; and randomly splitting the first matrix multiplication result into a matrix Vₐ₁ and a matrix V_{b1} by using an obfuscation technique specifically comprises:
splitting, by the first computation participant, the private matrix A₁ into a plurality of submatrices by using a rank-preserving secure 2-party matrix addition decomposition technique; and splitting, by the second computation participant, the private matrix B₂ into a plurality of submatrices by using the rank-preserving secure 2-party matrix addition decomposition technique, wherein the private matrix A₁=A₁₁+A₁₂+A₁ᵢ+ . . . +A_{1N}_{₁}, the private matrix B₂=B₂₁+B₂₂+B₂ⱼ+ . . . +B_{2T}_{₁}, a rank of the private matrix A₁ equals a sum of ranks of all submatrices A₁ᵢ, and a rank of the private matrix B₂ equals a sum of ranks of all submatrices B₂ⱼ;
inputting, by the first computation participant and the second computation participant, a submatrix A₁ᵢ and a submatrix B₂ⱼ of each first submatrix product combination respectively based on the secure two-party matrix multiplication protocol, to perform secure two-party matrix multiplication to obtain a first matrix multiplication result corresponding to the first submatrix product combination; and randomly splitting each first matrix multiplication result into a matrix Vₐ₁ₑ and a matrix V_{b1e} by using the obfuscation technique, wherein each submatrix of the private matrix A₁ and each submatrix of the private matrix B₂ are randomly combined to obtain N₁×T₁ first submatrix product combinations, i=1, 2, . . . , and N₁; j=1, 2, . . . , and T₁; e=1, 2, . . . , and N₁×T₁; and
obtaining the matrix Vₐ₁ based on the matrix Vₐ₁ₑ corresponding to each first submatrix product combination, and obtaining the matrix V_{b1} based on the matrix V_{b1e} corresponding to each first submatrix product combination.

11. The computer-readable storage medium according to claim 10, wherein the inputting, by the first computation participant and the second computation participant, the private matrix A₂ and the private matrix B₁ respectively based on the secure two-party matrix multiplication protocol, to perform secure two-party matrix multiplication to obtain a second matrix multiplication result; and randomly splitting the second matrix multiplication result into a matrix Vₐ₂ and a matrix V_{b2} by using the obfuscation technique specifically comprises:
splitting, by the first computation participant, the private matrix A₂ into a plurality of submatrices by using the rank-preserving secure 2-party matrix addition decomposition technique; and splitting, by the second computation participant, the private matrix B₁ into a plurality of submatrices by using the rank-preserving secure 2-party matrix addition decomposition technique, wherein the private matrix A₂=A₂₁+A₂₂+A₂ₛ+ . . . +A_{2N}_{₂}, the private matrix B₁=B₁₁+B₁₂+B_{1f}+ . . . +B_{1T}_{₂}, a rank of the private matrix A₂ equals a sum of ranks of all submatrices A₂ₛ, and a rank of the private matrix B₁ equals a sum of ranks of all submatrices B_{1f};
inputting, by the first computation participant and the second computation participant, a submatrix A₂ₛ and a submatrix B_{1f} of each second submatrix product combination respectively based on the secure two-party matrix multiplication protocol, to perform secure two-party matrix multiplication to obtain a second matrix multiplication result corresponding to the second submatrix product combination; and randomly splitting each second matrix multiplication result into a matrix V_{a2g} and a matrix V_{b2g} by using the obfuscation technique, wherein each submatrix of the private matrix A₂ and each second submatrix of the private matrix B₁ are randomly combined to obtain N₂×T₂ second submatrix product combinations, s=1, 2, . . . , and N₂; f=1, 2, . . . and T₂; g=1, 2, . . . , and N₂×T₂; and
obtaining the matrix Vₐ₂ based on the matrix V_{a2g} corresponding to each second submatrix product combination, and obtaining the matrix V_{b2} based on the matrix V_{b2g} corresponding to each second submatrix product combination.

12. The computer-readable storage medium according to claim 10, wherein the splitting, by the first computation participant, the private matrix A₁ into a plurality of submatrices by using a rank-preserving secure 2-party matrix addition decomposition technique specifically comprises:
determining, by the first computation participant, the rank of the private matrix A₁; determining whether the rank of the private matrix A₁ equals 1; and if the rank of the private matrix A₁ equals 1, skipping performing matrix decomposition on the private matrix A₁; or
if the rank of the private matrix A₁ does not equal 1, performing elementary row transformation on the private matrix A₁ to obtain a row echelon matrix and a non-singular matrix Pₐ of the private matrix A₁, and performing elementary column transformation on the row echelon matrix to obtain a canonical matrix F and a non-singular matrix Qₐ of the private matrix A₁;
decomposing the canonical matrix F into N₁ canonical submatrices based on the rank of the private matrix A₁ and a preset matrix decomposition quantity of the private matrix A₁ in a manner of performing row/column partitioning without overlapping, wherein each canonical submatrix comprises a sparse diagonal matrix and a null matrix, and the sparse diagonal matrix consists of elements 0 and 1; and
performing invertible transformation on each canonical submatrix based on the non-singular matrix Pₐ and the non-singular matrix Qₐ, to obtain N₁ submatrices A₁ᵢ.
